(19) United States
(12) Patent Application Publication
(10) Pub. No.: US 2011/0209148 A1
(43) Pub. Date: Aug. 25, 2011

(54) INFORMATION PROCESSING DEVICE, VIRTUAL MACHINE CONNECTION METHOD, PROGRAM, AND RECORDING MEDIUM

(75) Inventors: Koichi YAMASAKI, Kawasaki (JP); Kazuki Matsui, Kawasaki (JP); Takashi Ohno, Kawasaki (JP); Ryo Miyamoto, Kawasaki (JP)

(73) Assignee: Fujitsu Limited, Kawasaki-shi (JP)

(21) Appl. No.: 13/032,164

(22) Filed: Feb. 22, 2011

(30) Foreign Application Priority Data
Feb. 25, 2010 (JP) 2010-40708

(51) Int. Cl. G06F 9/455

(52) U.S. Cl. 718/1

(57) ABSTRACT

An information processing device includes: a first connection method for logically connecting the first communication unit and the virtual machine to each other, an address notification method for giving notice of first address information indicating a transmission destination of data to be transmitted by the external device and causing the external device to set the first address information, when a connection is established on the basis of the first connection method, a first determination method for determining whether there is an abnormal connection between the first communication unit and the virtual machine, a second connection method for logically connecting the second communication unit and the virtual machine to each other when the first determination method determines that there is an abnormal connection, and a switching method for giving notice of second address information.

### CROSS-REFERENCE TO RELATED APPLICATIONS

This application is based upon and claims the benefit of priority of the prior Japanese Patent Application No. 2010-40708, filed on Feb. 25, 2010, the entire contents of which are incorporated herein by reference.

### FIELD

One embodiment relates to an information processing device that uses a virtual machine from an external device, a virtual machine connection method, a program, and a recording medium.

### BACKGROUND

There has been a system in which a plurality of virtual machines (VMs) to function as virtual computers on one server device are operated and the VMs are individually allocated to a plurality of terminal devices connected to the server device through a network. In the system, an Operating System (OS) operates on each VM that runs in the server device, and a user of each terminal device uses the OS of the allocated VM from the user's terminal device. Namely, the server device is used as the desktop computer of each terminal device.

From the terminal device, the user not only uses the OS on the VM but may freely change an environment setting on the VM, for example, the setting of the network, the setting of a firewall, or the like. Therefore, when a wrong setting is configured, a problem that the terminal device is not able to connect to the VM may occur. In this case, the user of the terminal device requests the administrator of the server device to remove a factor causing connection impossibility to occur, such as the setting of the network, the setting of a firewall, or the like. Therefore, a problem that an effort such as a request to the administrator is necessary for the user and a responsibility such as the necessity of performing a recovery work rests on the administrator occurs. Consequently, in Japanese Unexamined Patent Application Publication No. 2009-151509, a technique is discussed in which, by aggregating the information of failures occurring in the OS on the VM, the monitoring of the failures is easily carried out.

### SUMMARY

According to an aspect of the invention, an information processing device includes: first and second communication units to which an external device is connected through a network; a processing unit that executes a processing operation; and a memory unit that stores the processing operation and information used in the processing operation, wherein the processing operation executed by the processing unit includes a virtual machine processing operation for causing a virtual machine used by the external device to operate, a first connection processing operation for logically connecting the first communication unit and the virtual machine to each other, an address notification processing operation for giving notice of first address information indicating a transmission destination of data to be transmitted by the external device and causing the external device to set the first address information, when a connection is established on the basis of the first connection processing operation, a first determination processing operation for determining whether there is an abnormal connection between the first communication unit and the virtual machine, a second connection processing operation for logically connecting the second communication unit and the virtual machine to each other when the first determination processing operation determines that there is an abnormal connection, and a switching processing operation for giving notice of second address information indicating a transmission destination of data to be transmitted by the external device and causing the external device to switch to the second address information, when a connection is established on the basis of the second connection processing operation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a computer system that includes a server device;

FIG. 2 is a pattern diagram for explaining a connection between a VM in a server device and a terminal device;

FIG. 3 is a block diagram illustrating hardware configurations of the server device and the terminal device;

FIG. 4 is a block diagram illustrating a function included in the server device;

FIG. 5 is a flowchart illustrating a procedure performed by the server device when the use of the VM is started and ended;

FIG. 6 is a flowchart illustrating a procedure performed by a network monitoring unit in the VM;

FIG. 7 is a flowchart illustrating a procedure performed by a VM information collection unit in the VM;

FIG. 8 is a flowchart illustrating a procedure performed by a packet monitoring unit in a VMM;

FIG. 9 is a flowchart illustrating a procedure performed by a VM state monitoring unit in a management OS;

FIG. 10 is a flowchart illustrating a procedure performed by the VM state monitoring unit in the management OS;

FIG. 11 is a flowchart illustrating a procedure performed by the VM state management unit in the management OS;

FIG. 12 is a flowchart illustrating a procedure performed by the VM state monitoring unit in the management OS;

FIG. 13 is a schematic view illustrating an example of a screen for informing a user of abnormity;

FIG. 14 is a block diagram schematically illustrating a function included in a terminal device;

FIG. 15 is a flowchart illustrating a procedure performed by a network connection monitoring unit in the terminal device;

FIG. 16 is a flowchart illustrating a procedure performed by the VM state management unit in the management OS;

FIG. 17 is a flowchart illustrating a procedure performed by the VM state management unit in the management OS;

FIG. 18 is a flowchart illustrating a procedure performed by the network monitoring unit in the VM;

FIG. 19A is a schematic view illustrating an example of a screen for allocating the remote connection card, displayed on a monitor in the terminal device;

FIG. 19B is a schematic view illustrating an example of a screen for releasing the remote connection card allocated to the VM, displayed on the monitor in the terminal device;

FIG. 20 is a block diagram illustrating a function included in the server device;

FIG. 21 is a flowchart illustrating a procedure performed by the server device when the use of the remote connection card is started;

FIG. 22 is a flowchart illustrating a procedure performed by the server device when the use of the remote connection card is ended;

FIG. 23 is a flowchart illustrating a procedure performed by the server device when allocation release is temporarily performed for an allocated device;

FIG. 24 is a block diagram illustrating a function included in the server device;

FIG. 25 is a flowchart illustrating a procedure performed in the VM information collection unit in the VM;

FIG. 26 is a flowchart illustrating a procedure performed in the VM state management unit in the management OS; and

FIG. 27 is a flowchart illustrating a procedure performed in a removal tool collection unit in the management OS.

### DESCRIPTION OF EMBODIMENTS

Even if, by aggregating the information of failures occurring in a virtual machine, a user's effort can be saved, it is difficult to remove an administrator's responsibility when the administrator of a server device, or the like, solves a problem.

In one embodiment, even if abnormality occurs in one path, an external device is connected to a virtual machine through another path, and thereby the virtual machine is used.

An information processing device includes first and second communication units to which an external device is connected through a network, a processing unit that executes a method, and a memory unit that stores the method and information used in the method. The method executed by the processing unit includes a virtual machine processing operation, a first connection method, an address notification method, a first determination method, a second connection method, and a switching method. The virtual machine processing operation causes a virtual machine used by the external device to operate. The first connection method logically connects the first communication unit and the virtual machine to each other. When a connection is established on the basis of the first connection method, the address notification method gives notice of first address information indicating the transmission destination of data to be transmitted by the external device, and causes the external device to set the first address information. The first determination method determines whether or not there is an abnormal connection between the first communication unit and the virtual machine. When the first determination method determines that there is the abnormal connection, the second connection method logically connects the second communication unit and the virtual machine to each other. When a connection is established on the basis of the second connection method, the switching method gives notice of second address information indicating the transmission destination of data to be transmitted by the external device, and causes the external device to switch to the second address information.

According to one viewpoint of the information processing device, even if it is not able to connect the external device and the virtual machine to each other via the first communication unit, the external device and the virtual machine are connected to each other via the second communication unit. Accordingly, for example, when, owing to a setting in the virtual machine, performed by a user of the external device, it is not able to connect the external device and the virtual machine to each other via a first input-output unit, the user removes the cause of the connection abnormality by himself without requesting the administrator to remove the cause. As a result, an administrator's responsibility is reduced when the connection abnormality occurs, and the user saves an effort such as a request to the administrator.

Hereinafter, an information processing device, a virtual machine connection method, a program, and a recording medium will be described in detail on the basis of figures. While, hereinafter, the information processing device will be described as a server device, the information processing device may be a personal computer (hereinafter, called PC) including a keyboard and a monitor.

### Embodiment

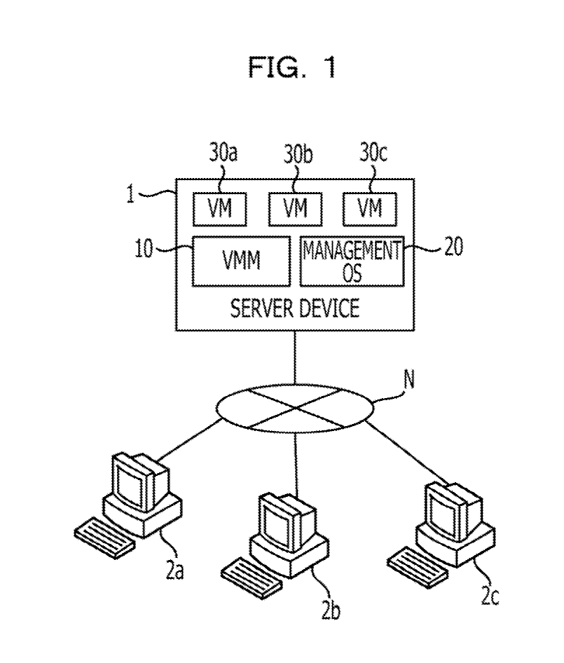

FIG. 1 is a diagram schematically illustrating a computer system that includes a server device.

A server device 1 is connected to a plurality of terminal devices 2a, 2b, and 2c through a network N such as a local area network (LAN), a wide area network (WAN), or the like. For example, the terminal devices 2a, 2b, and 2c are PCs individually including keyboards, mice, monitors, and the like. The terminal devices 2a, 2b, and 2c may be set top boxes (STBs) connected to monitors, personal digital assistants (PDAs), mobile phones, or the like. In addition, the type of the network N may be arbitrarily changed, and connections between the server device 1 and the terminal devices 2a, 2b, and 2c may be established using any one of wired and wireless connections.

The server device 1 has the capability of executing a virtual machine monitor (VMM) 10 and a management OS 20. By executing the VMM 10, the server device 1 makes a plurality of VMs 30a, 30b, and 30c (three VMs in FIG. 1) to run. The VMM 10 activates the VMs 30a, 30b, and 30c in response to an instruction from the management OS 20. For example, the VMM 10 logically divides into plural portions the resources of the server device 1, such as a central processing unit (CPU), a random access memory (RAM), and the like, and allocates the divided resources to the activated VMs 30a, 30b, and 30c. The management OS 20 is an OS used for managing the server device 1, and instructs the VMM 10 to activate and halt the VMs 30a, 30b, and 30c. The VMs 30a, 30b, and 30c are virtual computers that independently cause OSs and applications to be executed, in the same way as a physical computer.

Hereinafter, OSs executed in the VMs 30a, 30b, and 30c will be called guest OSs. Terminal devices 2a, 2b, and 2c are allocated to the VMs 30a, 30b, and 30c, respectively. The VMs 30a, 30b, and 30c are called VMs 30, and the terminal devices 2a, 2b, 2c are called terminal devices 2.

When accepting a connection request from the terminal device 2, the server device 1 performs user authentication between the server device 1 itself and the terminal device 2, for example, and activates the VM 30 and the guest OS, which correspond to the terminal device 2. Accordingly, a network connection between the VM 30 and the terminal device 2 is established, and the utilization of the VM 30 from the terminal device 2 is started. When the VM 30 is used by the terminal device 2, the server device 1 packet-transfers screen data to the terminal device 2, and causes the monitor of the terminal device 2 to display a screen. In addition, the server device 1 receives the packets of operation information input from the keyboard and the mouse of the terminal device 2, causes the corresponding VM 30 to execute a processing operation, and transmits the result thereof to the terminal device 2.

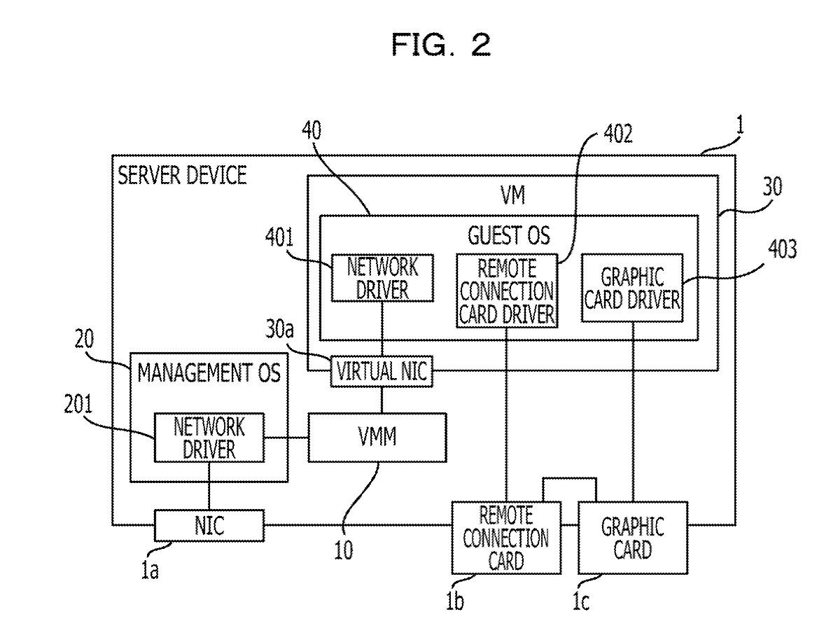

A connection between the VM 30 in the server device 1 and the terminal device 2 is established using two paths. Hereinafter, a path establishing a connection between the VM 30 in the server device 1 and the terminal device 2 will be described. FIG. 2 is a pattern diagram for explaining a connection between the VM 30 in the server device 1 and the terminal device 2. In addition, in FIG. 2, one VM 30 is illustrated.

The server device 1 includes a network interface card (NIC) 1a, a remote connection card 1b, a graphic card 1c, and the like, which are used as I/O interfaces for connecting to the terminal device 2 through the network N. The terminal device 2 connects to the NIC (a first communication unit) 1a and the remote connection card (a second communication unit) 1b. In addition, while the server device 1 is illustrated in FIG. 2 as a device including one NIC, the server device 1 includes as many NICs 1a. Furthermore, the NIC is shared with the plural VMs 30. In addition, the server device 1 includes one or more remote connection cards 1b and one or more graphic cards 1c.

In the management OS 20 in the server device 1, a network driver 201 for the NIC is executed. In addition, a virtual NIC 30a runs in the VM 30, and a network driver 401 for the virtual NIC 30a is executed in a guest OS 40 running in the VM 30. The network driver 201 in the management OS 20 is associated with the virtual NIC 30a through the VMM 10. The server device 1 notifies the terminal device 2 of the Internet protocol (IP) address of the NIC 1a, and the terminal device 2 transmits packets to the IP address. In this case, packets transmitted from the terminal device 2 is received by the NIC 1a and input to the guest OS 40 through the management OS 20, the VMM 10, and the virtual NIC 30a in the VM 30. In addition, packets sent by the guest OS 40 is transmitted from the virtual NIC 30a through the VMM 10 and the management OS 20, and is transmitted from the NIC is to the terminal device 2. Examples of a connection established via the NIC is include an RDP connection.

In addition, in the guest OS 40 in the VM 30, a remote connection card driver 402 for the remote connection card 1b and a graphic card driver 403 for the graphic card is are executed. The remote connection card 1b and the graphic card is are concurrently allocated to one VM 30, and the behavior of the remote connection card 1b and the graphic card is are controlled by the drivers 402 and 403 in the VM 30, respectively. Hereinafter, when allocating the remote connection card 1b to the VM 30, it means that the graphic card is corresponding to the remote connection card 1b is concurrently allocated to one VM 30. The server device 1 notifies the terminal device 2 of the IP address of the remote connection card 1b, and the terminal device 2 transmits packets to the IP address. In this case, the operation information of the keyboard, the mouse, and the like of the terminal device 2 is converted into Internet-protocol-based data and input to the remote connection card 1b. The remote connection card 1b directly inputs the input operation data to the guest OS 40. In addition, the screen data of the guest OS 40 is output to the graphic card 1c, and after being converted into Internet-protocol-based data by the remote connection card, the screen data is transmitted to the terminal device 2. Examples of a communication technology performed via the remote connection card 1b include a PC-over-IP technology.

As described above, the VM 30 and the terminal device 2 are connected to each other via the NIC is or the remote connection card 1b. For example, the VM 30 and the terminal device 2 are connected to each other via the NIC is at normal times. In the VM 30, the corresponding terminal device 2 can establish a network configuration. For example, the network configuration includes the setting of the IP address of the terminal device 2 or the VM 30, the setting of a firewall running in the guest OS 40, and the like. When there is an error in the network configuration, a case may occur in which it is difficult to establish a connection between the VM 30 and the terminal device 2. For example, when, in the firewall setting, an error occurs in an IP address to be set, a packet transmitted from the terminal device 2 is discarded by the firewall, and hence it is practically difficult to establish a connection between the guest OS 40 and the terminal device 2. In this case, the server device 1 switches to a connection so that the connection between the VM 30 and the terminal device 2 is established via the remote connection card 1b. Accordingly, the terminal device 2 resumes the connection to the VM 30, and the user establishes a correct network configuration for connecting to the VM 30 again via the NIC 1a.

In addition, when the connection between the VM 30 and the terminal device 2 is re-established via the NIC 1a, the allocation of the remote connection card 1b and the graphic card is to one VM 30 is released. Accordingly, since the remote connection card 1b and the like are allocated to another VM 30 when the other VM 30 uses the remote connection card 1b and the like, the number of the remote connection cards 1b included in the server device 1 may be set to a smaller number than the number of the VMs to be activated.

Hereinafter, the configuration and the behavior of the server device 1 will be described in detail.

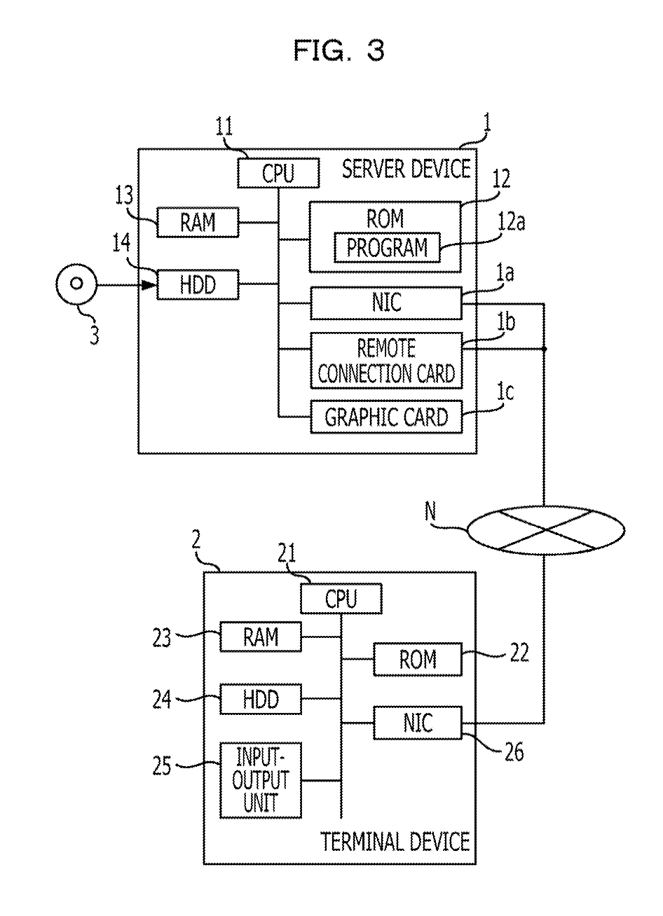

FIG. 3 is a block diagram illustrating the hardware configurations of the server device 1 and the terminal device 2.

The server device 1 includes individual hardware units such as a CPU 11, a read only memory (ROM) 12, a RAM 13, a hard disk drive (HDD) 14, the network interface card (NIC) 1a, the remote connection card 1b, the graphic card 1c, and the like. These individual hardware units are connected to one another through a bus.

The CPU 11 arbitrarily reads out and deploys a program 12a preliminarily stored in the ROM 12 or the HDD 14 to the RAM 13, executes the program 12a, and controls the behavior of the individual hardware units described above. The ROM 12 or the HDD 14 stores therein the program 12a. For example, the RAM 13 is a static RAM (SRAM), a dynamic RAM (DRAM), a flash memory, or the like. The RAM 13 temporarily stores therein various kinds of data occurring when the program 12a is executed by the CPU 11.

The HDD 14 is a large-capacity storage device. The HDD 14 stores therein a VMM program, a management OS program, a guest OS program, an application program, data tables used for individual processing, and the like. The individual programs are read out and deployed to the RAM 13 and executed by the CPU 11. In addition, the program 12a may be installed into the HDD 14 using a recording medium 3 such as a compact disk-ROM (CD-ROM), a digital versatile disc-ROM (DVD-ROM), or the like. The program 12a may be downloaded from a network, and may be read out and deployed to the RAM 13, thereby being executed. The program 12a may be downloaded from a network and installed into the HDD 14.

The VMM program is a software program used for making the VM 30 to run in the server device 1, and is a software program used for realizing a virtualization technology. By executing the VMM program after the activation of the server device 1, the CPU 11 starts behavior as the VMM 10. The behavior of the CPU 11 as the VMM 10 results in providing the server device 1 with a virtual environment in which the plural VMs 30 independently run.

The management OS program is a software program used for activating and halting the VM 30 on the VMM 10, allocating resources such as the CPU 11 and the like to the VM 30, and instructing the VMM 10 to allocate. By executing the management OS program after the activation of the server device 1, the CPU 11 starts behavior as the management OS 20.

The guest OS program is a software program used for making the guest OS 40 to run on the VM 30. The CPU 11 executes the guest OS program after the activation of the VM, and hence the guest OS program starts behavior as the guest OS 40. For example, the guest OS 40 is Windows (registered trademark), Linux (registered trademark), or the like. The guest OS generates, in response to an executed processing operation, a display screen to be displayed, which includes a character user interface (CUI), a graphic user interface (GUI), and the like, and the generated display screen is sent to the terminal device 2 and displayed on the monitor of the terminal device 2. In addition, the guest OS 40 accepts control signals from the keyboard and the mouse of the terminal device 2. In addition, the guest OS 40 executes various kinds of processing in response to the accepted control signals.

The application program is the software program of an application executed by each guest OS 40. The server device 1 may read out the application program from an external memory in which the application program is stored, and store the application program in the HDD 14. In addition, the server device 1 may download and store the application program through the network and to the HDD 14.

The terminal device 2 includes individual hardware units such as a CPU 21, a ROM 22, a RAM 23, a HDD 24, an input-output unit 25, an NIC 26, and the like. These individual hardware units are connected to one another through a bus. The input-output unit 25 corresponds to a keyboard, a mouse, a monitor, and the like. The NIC 26 connects the terminal device 2 to the network N.

The CPU 21 arbitrarily reads out and deploys a program preliminarily stored in the ROM 22 to the RAM 23, executes the program, and controls the behavior of the individual hardware units described above. The ROM 22 preliminarily stores therein a program, various kinds of data, and the like. For example, the RAM 23 is an SRAM, a DRAM, a flash memory, or the like, and temporarily stores therein various kinds of data occurring when the program is executed by the CPU 12. For example, the HDD 22 stores therein the program of an application used for connecting to the server device 1, various kinds of data, and the like.

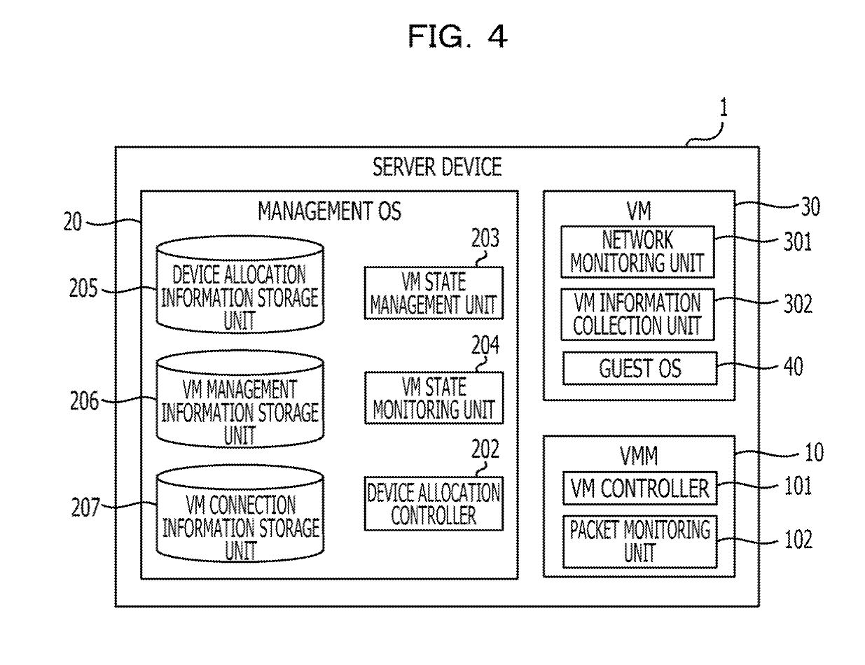

Hereinafter, a function realized by the server device 1 will be described. FIG. 4 is a block diagram illustrating a function included in the server device 1.

When the server device 1 is powered on and the activation of the individual hardware units in the server device 1 are completed, first the CPU 11 reads out and executes the VMM program from the HDD 14, thereby starting behavior as the VMM 10. The CPU 11 that has started behavior as the VMM 10 reads out and executes the management OS program from the HDD 14, thereby starting behavior as the management OS 20. The VMM 10 performs the activation and halting of the VM 30 on the VMM 10 in response to an instruction from the management OS 20. In addition, in FIG. 4, one VM 30 is illustrated.

When the VM 30 is activated, the management OS 20 performs user authentication. For example, the server device 1 preliminarily registers thereon a user ID and a password with associating the user ID and the password with the VM 30 used by the user. The management OS 20 transmits to the terminal device 2 screen data for a login screen (not illustrated in FIG. 4), and receives from the terminal device 2 a user ID and a password input in accordance with the login screen displayed by the terminal device 2. In addition, the management OS 20 determines whether the received user ID and the received password are registered. When the received user ID and the received password are registered, the management OS 20 determines that the user authentication is completed, and the VMM 10 activates the corresponding VM 30 and allocates resources to the activated VM 30. In the activated VM 30, the behavior of the guest OS 40 is started.

The VMM 10 includes the functions of a VM controller 101, a packet monitoring unit 102, and the like. The VM controller 101 performs the activation and the halting of the VM 30, and the like in accordance with an instruction from the management OS 20. The packet monitoring unit 102 periodically monitors packets transmitted and received between the VM 30 and the terminal device 2 through the VMM 10, in accordance with an instruction from the management OS 20, and notifies the management OS 20 of the monitoring result. The packets transmitted and received between the VM 30 and the terminal device 2 include a packet (hereinafter, called a request packet) transmitted from the terminal device 2 to the VM 30 and a packet (hereinafter, called a response packet) transmitted from the VM 30 to the terminal device 2.

The management OS 20 includes the functions of a device allocation controller 202, a VM state management unit 203, a VM state monitoring unit 204, a device allocation information storage unit 205, a VM management information storage unit 206, a VM connection information storage unit 207, and the like. In addition, while being omitted in FIG. 4, the function of the above-mentioned network driver 201 is included in the management OS 20.

In accordance with an instruction from the VM state management unit 203, the device allocation controller 202 requests the VMM 10 to allocate a device to the activated VM 30 and release the allocation thereof. The device subjected to the allocation and the allocation release corresponds to the remote connection card 1b, the graphic card 1c, and the like.

When the VM 30 is activated, the VM state management unit 203 stores VM information relating to the VM 30 in the VM management information storage unit 206, and when the VM 30 is halted, the VM state management unit 203 deletes the stored VM information. For example, the VM information includes the VM name of the VM 30, a domain ID used by the VMM 10 for identifying the VM 30, the name of the virtual NIC 30a (hereinafter, called an interface (I/F) name), and the like. The VM information includes an IP address allocated to the virtual NIC 30a, a network mask, gateway information, a firewall log described later, and the like. In addition, the VM 30 is connected to the terminal device 2, the VM information includes the connection information thereof and device information allocated to the VM 30.

In addition, the VM state management unit 203 determines whether a connection between the VM 30 and the terminal device 2 is abnormal. When the connection between the VM 30 and the terminal device 2 is abnormal, the VM state management unit 203 requests the device allocation controller 202 to allocate the remote connection card 1b and the graphic card is to the corresponding VM 30. When the remote connection card 1b is allocated, the VM state management unit 203 notifies the terminal device 2 of the IP address of the remote connection card 1b, and makes the terminal device 2 to be connected to the VM 30 via the remote connection card 1b. Accordingly, the VM 30 and the terminal device 2 are connected to each other via the remote connection card 1b.

In addition, the VM state management unit 203 requests the terminal device 2 to transmit a monitoring packet. After the remote connection card 1b is allocated to the VM 30, the monitoring packet is issued in order to confirm that the VM 30 can be connected to the terminal device 2 via the virtual NIC 30a. The monitoring packet uses an Internet control message protocol (icmp) echo for an IP address allocated to the NIC 30a of the VM 30. When an icmp reply response occurs in response to the monitoring packet, the VM state management unit 203 determines that a connection via the NIC is available, and releases the allocation of the remote connection card 1b allocated to the VM 30. At this time, the VM state management unit 203 notifies the terminal device 2 of the IP address of the Virtual NIC 30a, and makes the VM 30 and the terminal device 2 to be connected to each other via the NIC 1a. In addition, the VM state management unit 203 requests the terminal device 2 to stop the monitoring packet.

After giving notice of a request for the transmission of the monitoring packet, the VM state management unit 203 instructs through the VM state monitoring unit 204 the VM 30 to acquire the VM information. In addition, when receiving the VM information, the VM state management unit 203 updates the VM information stored in the VM management information storage unit 206.

In addition, when a connection between the VM 30 and the terminal device 2 is established, the VM state management unit 203 acquires connection information from the VM 30 and stores connection information into the VM connection information storage unit 207. For example, the connection information includes the IP address and the port number of the terminal device 2 connected to the VM 30 and the IP address and the port number of the VM 30. The VM state management unit 203 stores information (flag), which indicates whether the monitoring packet is being monitored, into the VM connection information storage unit 207 with including the information in the connection information.

In accordance with an instruction from the VM state management unit 203, the VM state monitoring unit 204 periodically monitors a request packet and a response packet, and notifies the VM state management unit 203 of the monitoring result. In addition, in accordance with an instruction from the VM state management unit 203, the VM state monitoring unit 204 confirms whether the VM 30 to be a target is activated, and when the VM 30 is activated, the VM state monitoring unit 204 instructs the VM 30 to acquire the VM information. When receiving the VM information, the VM state monitoring unit 204 notifies the VM state management unit 203 of the result.

The device allocation information storage unit 205 stores therein device information relating to devices to be allocated to the VM 30, for example, the remote connection card 1b and the graphic card 1c. For example, the device information includes an identifier for identifying a device, a domain number used for specifying a location (for example, the location of a board slot) to which the device is connected, a bus number, a device number, a function number, an IP address allocated to the device, and the like. In addition, when a device has already been allocated to the VM 30, the device information includes the VM name of the VM 30 to which the device is allocated, and the like.

The VM 30 includes the functions of a network monitoring unit 301, a VM information collection unit 302, and the like. When the VM 30 starts a connection with the terminal device 2, the network monitoring unit 301 notifies the VM state management unit 203 in the management OS 20 of the start of connection in addition to the connection information. The network monitoring unit 301 periodically monitors a request packet and a response packet, and notifies the VM state management unit 203 in the management OS 20 of the monitoring result. Furthermore, when a connection between the terminal device 2 and the VM 30 is terminated, the network monitoring unit 301 notifies the VM state management unit 203 of the connection termination, and terminates packet monitoring.

The VM information collection unit 302 acquires the VM information such as a network state, a firewall log, or the like in accordance with an instruction from the VM state management unit 203. The network state is an IP address and the port number relating to a connection. The firewall log is the log of an accepted packet or a discarded packet, etc. When there is an abnormal connection between the VM 30 and the terminal device 2, the VM information collection unit 302 detects a cause of the abnormality from the acquired network state or the firewall log, and outputs the VM information to the VM state monitoring unit 204 in addition to the detection result.

For example, the VM information collection unit 302 acquires the VM information stored in the VM management information storage unit 206 from the management OS 20, and compares the VM information with a network state the VM information collection unit 302 itself acquires. As a comparative result, when an I/F name is different, the VM information collection unit 302 regards the invalidation of the virtual NIC 30a or the change of the setting of the virtual NIC 30a as the cause of the abnormality, and hence determines that an I/F is abnormal. In addition, as the comparative result, when an I/F address is different, the VM information collection unit 302 regards the change of the IP address as the cause of the abnormality, and hence determines that the IP address is abnormal. In addition, the VM information collection unit 302 acquires the connection information from the VM connection information storage unit 207, and when a packet discarded in the firewall log is a packet from an IP address or a port number included in the connection information, the VM information collection unit 302 determines that a firewall is abnormal. The VM information collection unit 302 notifies the VM state management unit 203 of a result obtained by determining the cause of the abnormality, through the VM state monitoring unit 204.

Next, a processing operation performed in the above-mentioned server device 1 will be described.

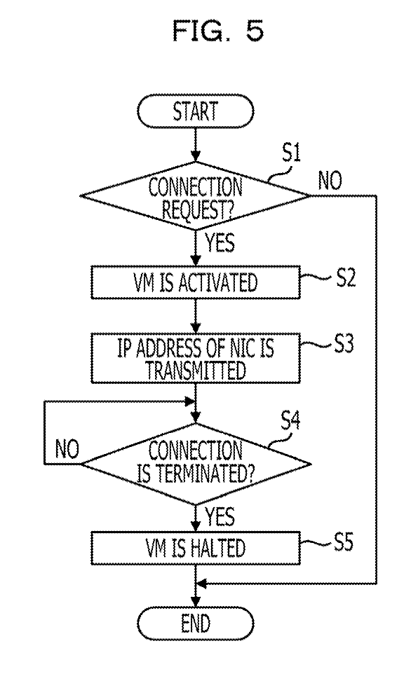

FIG. 5 is a flowchart illustrating the procedure performed by the server device 1 when the use of the VM 30 is started and is ended. In addition, FIG. 5 illustrates a case in which the VM 30 is normally activated and halted and there is no abnormal connection between the VM 30 and the terminal device 2.

The VMM 10 is executed in the server device 1, and the management OS 20 is started to work on the VMM 10. The activated management OS 20 determines whether a connection request is received from the terminal device 2 (51). For example, by executing the certain application in the terminal device 2, the connection request is transmitted from the terminal device 2. When the connection request is not received (S1: NO), the procedure is terminated. When the connection request is received (S1: YES), the management OS 20 requests the VMM 10 to activate the VM 30 corresponding to the terminal device 2 that has made a connection request, and the VMM 10 activates the VM 30 (S2).

The management OS 20 transmits to the terminal device 2 the IP address of the NIC 30a in the activated VM 30 (S3). In the terminal device 2, a connection to the transmitted IP address is started. Accordingly, a connection between the VM 30 and the terminal device 2 is established, and a remote connection from the terminal device 2 to the VM 30 is started. When the connection between the VM 30 and the terminal device 2 is established, the management OS 20 stores in the VM management information storage unit 206 the VM information acquired from the activated VM 30.

The management OS 20 determines whether the remote connection is normally terminated (S4). When the remote connection is not normally terminated (S4: NO), the management OS 20 waits until the remote connection is normally terminated. At this time, the remote connection from the terminal device 2 to the VM 30 is continued. When the remote connection is normally terminated (S4: YES), the management OS 20 makes the VMM 10 to halt the VM 30 (S5). At this time, the VM 30 deletes the VM information stored in the VM management information storage unit 206. Then, the procedure is finished.

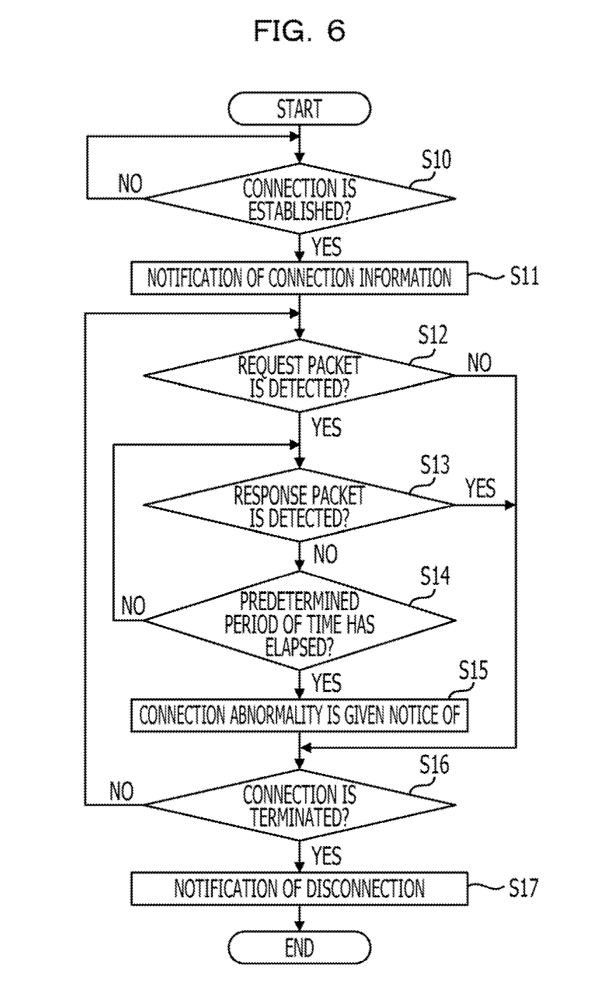

FIG. 6 is a flowchart illustrating the procedure performed by the network monitoring unit 301 in the VM 30.

The network monitoring unit 301 determines whether a connection between the VM 30 and the terminal device 2 is established (S10). When the connection between the VM 30 and the terminal device 2 is not established (S10: NO), the network monitoring unit 301 waits until the connection between the VM 30 and the terminal device 2 is established. When the connection between the VM 30 and the terminal device 2 is established (S10: YES), the network monitoring unit 301 notifies the VM state management unit 203 of connection information such as the IP address of the terminal device 2 etc. (S11). Next, the network monitoring unit 301 starts packet monitoring, and determines whether a request packet from the terminal device 2 is detected (S12).

When the request packet is detected (S12: YES), the network monitoring unit 301 determines whether a response packet from the guest OS 40, which responds to the request packet, is detected (S13). When the response packet is not detected (S13: NO), the network monitoring unit 301 determines whether a specified period of time has elapsed (S14). When the specified period of time has not elapsed (S14: NO), the network monitoring unit 301 re-executes S13, and determines whether a request packet is detected. When the specified period of time has elapsed (S14: YES), the network monitoring unit 301 determines that there is an abnormal connection between the VM 30 and the terminal device 2, and notifies the VM state management unit 203 in the management OS 20 of the connection abnormality (S15). When the request packet is not detected (S12: NO) or the response packet is detected (S13: YES), the network monitoring unit 301 executes the process in S16. In addition, when the response packet is detected, the network monitoring unit 301 may notify the VM state management unit 203 that there is no abnormal connection between the VM 30 and the terminal device 2.

The network monitoring unit 301 determines whether the connection between the VM 30 and the terminal device 2 is terminated (S16). When the connection between the VM 30 and the terminal device 2 is not terminated (S16: NO), the network monitoring unit 301 executes the process in S12, and determines whether the request packet is detected. When the connection between the VM 30 and the terminal device 2 is terminated (S16: YES), the network monitoring unit 301 stops the packet monitoring, and finishes the procedure after notifying the management OS 20 of the disconnection (S17).

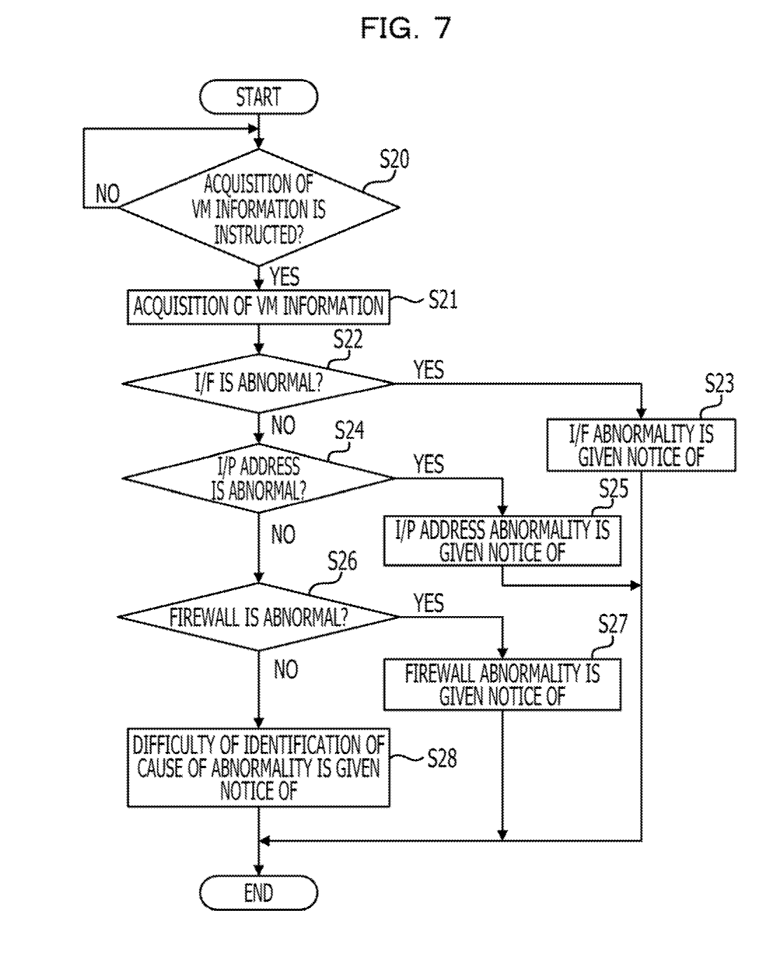

FIG. 7 is a flowchart illustrating the procedure performed by the VM information collection unit 302 in the VM 30.

The VM information collection unit 302 determines whether the acquisition of the VM information is instructed (S20). The acquisition of the VM information is instructed by the VM state management unit 203 notified of the connection abnormality, through the VM state monitoring unit 204. In addition, when the VM state management unit 203 is instructed by the VM state monitoring unit 204, the VM state management unit 203 acquires the VM information stored in the VM management information storage unit 206 and the connection information stored in the VM connection information storage unit 207. When the acquisition of the VM information is not instructed (S20: NO), the VM information collection unit 302 waits until the acquisition of the VM information is instructed by the VM state monitoring unit 204. When the acquisition of the VM information is instructed (S20: YES), the VM information collection unit 302 acquires the VM information (S21), and determines, on the basis of the acquired VM information, whether an I/F is abnormal (S22). For example, the VM information collection unit 302 determines whether an I/F name included in the VM information acquired from the management OS 20 has been acquired in S21.

When it is determined that the I/F is abnormal (S22: YES), the VM information collection unit 302 notifies the VM state monitoring unit 204 in the management OS 20 of I/F abnormality (S23), and terminates the procedure. When it is determined that the I/F is not abnormal (S22: NO), the VM information collection unit 302 determines whether an IP address is abnormal (S24). For example, the VM information collection unit 302 determines whether an IP address allocated to the virtual NIC 30a is included in the VM information acquired from the management OS 20 and matches an IP address allocated to the virtual NIC 30a. When the IP address does not match, it is determined that the IP address is abnormal.

When the IP address is abnormal (S24: YES), the VM information collection unit 302 notifies the VM state monitoring unit 204 in the management OS 20 of IP address abnormality (S25), and terminates the procedure. When the IP address is not abnormal (S24: NO), the VM information collection unit 302 determines whether a firewall is abnormal (S26). For example, the VM information collection unit 302 confirms a firewall log, and confirms whether there is a log influencing the connection, such as a log indicating that there is a discarded packet.

When it is determined that the firewall is abnormal (S26: YES), the VM information collection unit 302 notifies the VM state monitoring unit 204 in the management OS 20 of firewall abnormality (S27), and terminates the procedure. When it is determined that the firewall is not abnormal (S26: NO), the VM information collection unit 302 notifies the VM state monitoring unit 204 that it is difficult to identify the cause of abnormality (S28), and terminates the procedure.

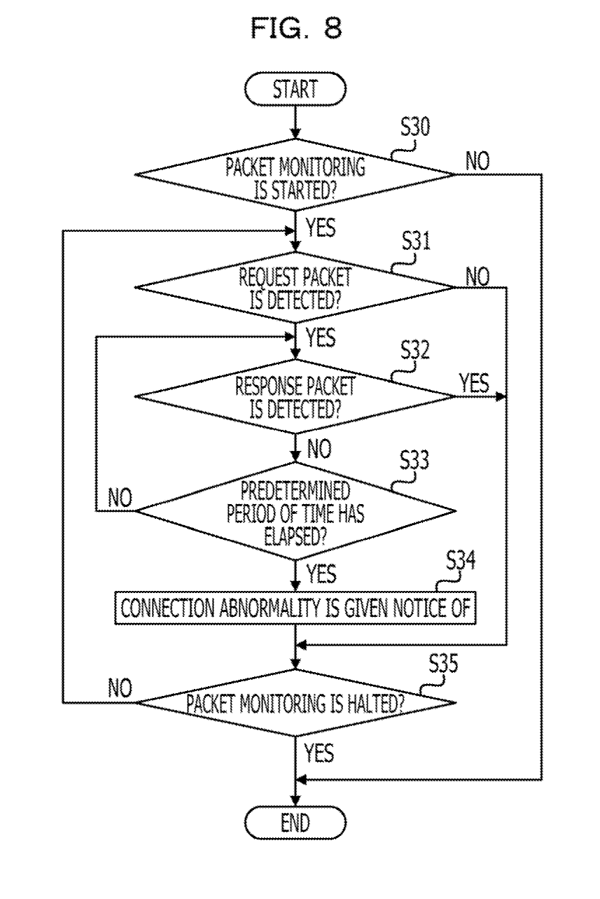

FIG. 8 is a flowchart illustrating the procedure performed by the packet monitoring unit 102 in the VMM 10.

The packet monitoring unit 102 determines whether packet monitoring is started in response to an instruction from the VM state monitoring unit 204 in the management OS 20 (S30). When the packet monitoring is not started (S30: NO), the packet monitoring unit 102 terminates the procedure. When the packet monitoring is started (S30: YES), the packet monitoring unit 102 determines whether a request packet from the terminal device 2 is detected (S31). When the request packet is detected (S31: YES), the packet monitoring unit 102 determines whether a response packet from the guest OS 40, which responds to the request packet, is detected (S32). When the request packet is not detected (S32: NO), the packet monitoring unit 102 determines whether a specified period of time has elapsed (S33).

When the specified period of time has not elapsed (S33: NO), the packet monitoring unit 102 executes a process in S32. When the specified period of time has elapsed (S33: YES), the packet monitoring unit 102 determines that a connection is abnormal, and notifies the VM state management unit 203 in the management OS 20 of connection abnormality (S34). When the request packet is not detected (S31: NO) or the response packet is detected (S32: YES), the packet monitoring unit 102 executes a process in S35. In addition, when the response packet is detected, the packet monitoring unit 102 may notify the VM state management unit 203 that the connection is normal.

The packet monitoring unit 102 determines whether packet monitoring is halted in response to an instruction from the VM state monitoring unit 204 (S35). When the packet monitoring is not halted (S35: NO), the packet monitoring unit 102 executes the process in S31. When the packet monitoring is halted (S35: YES), the packet monitoring unit 102 finishes the procedure after the packet monitoring is stopped.

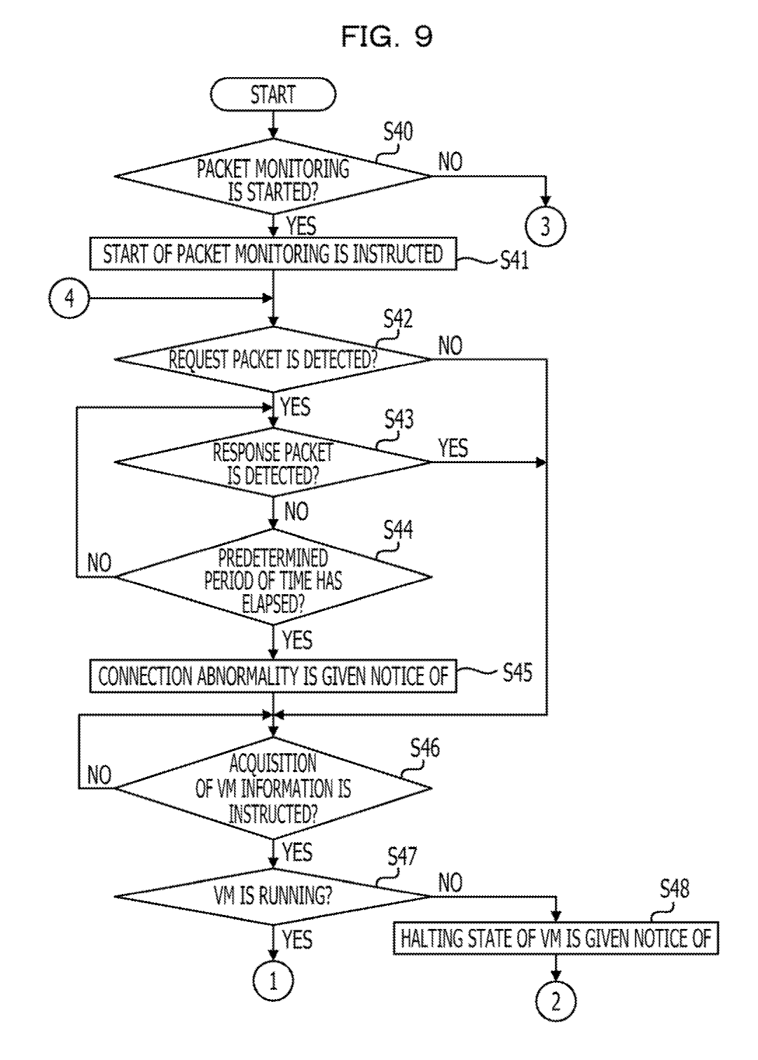

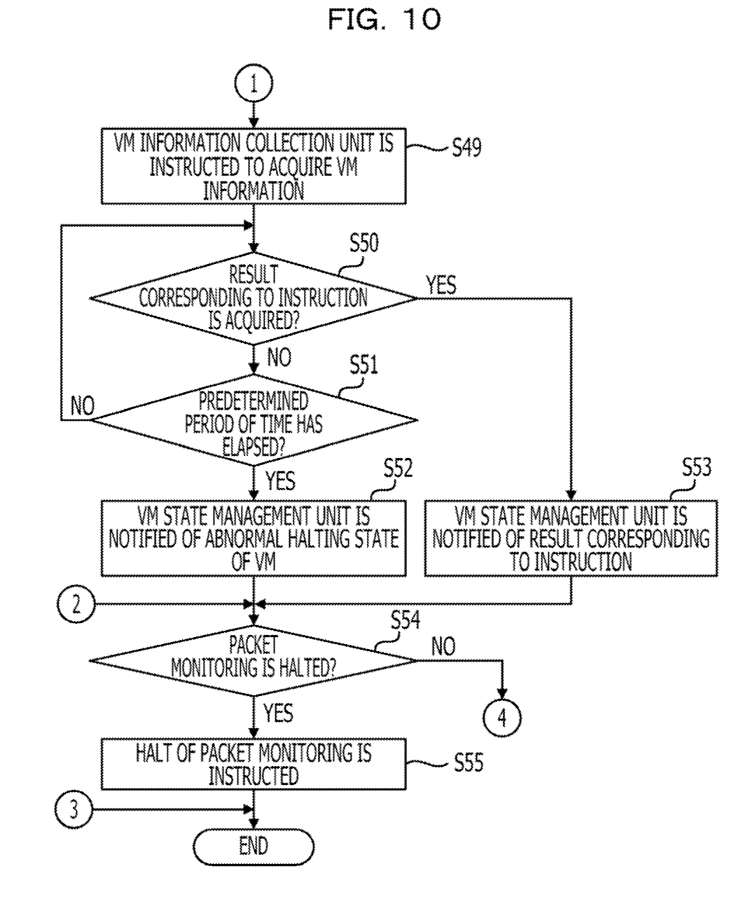

FIGS. 9 and 10 are flowcharts illustrating the procedure performed by the VM state monitoring unit 204 in the management OS 20.

The VM state monitoring unit 204 determines whether packet monitoring is started in response to an instruction from the VM state management unit 203 (S40). When the packet monitoring is not started (S40: NO), the VM state monitoring unit 204 terminates the procedure. When the packet monitoring is started (S40: YES), the VM state monitoring unit 204 instructs the packet monitoring unit 102 to start the packet monitoring (S41). At this time, the VM state monitoring unit 204 starts the packet monitoring performed by the VM state monitoring unit 204.

The VM state monitoring unit 204 determines whether a request packet from the terminal device 2 is detected (S42). When the request packet is detected (S42: YES), the VM state monitoring unit 204 determines whether a response packet of the guest OS 40, which responds to the request packet, is detected (S43). When the request packet is not detected (S43: NO), the VM state monitoring unit 204 determines whether a specified period of time has elapsed (S44).

When the specified period of time has not elapsed (S44: NO), the VM state monitoring unit 204 executes the process in S43. When the specified period of time has elapsed (S44: YES), the VM state monitoring unit 204 determines that a connection is abnormal, and notifies the VM state management unit 203 of connection abnormality (S45). When the request packet is not detected (S42: NO) or the response packet is detected (S43: YES), the packet monitoring unit 102 executes a process in S46. In addition, when the response packet is detected, the VM state monitoring unit 204 may notify the VM state management unit 203 that the connection is normal.

The VM state monitoring unit 204 determines whether the acquisition of the VM information is instructed (S46). The acquisition of the VM information is instructed by the VM state management unit 203 notified of the connection abnormality. When the acquisition of the VM information is not instructed (S46: NO), the VM state monitoring unit 204 waits until the acquisition of the VM information is instructed. When the acquisition of the VM information is instructed (S46: YES), the VM state monitoring unit 204 determines whether the VM 30 is running (S47). When the VM 30 is not running (S47: NO), the VM state monitoring unit 204 notifies the VM state management unit 203 that the VM 30 is in a halted state (S48), and executes a process in S54. In addition, the VM state management unit 203 notified that the VM 30 is in a halted state notifies the terminal device 2 that the VM 30 is in a halted state.

When the VM 30 is running (S47: YES), the VM state monitoring unit 204 instructs the VM information collection unit 302 in the VM 30 to acquire the VM information (S49). The VM state monitoring unit 204 determines whether a result corresponding to the instruction is acquired from the VM information collection unit 302 (S50). The result corresponding to the instruction includes the VM information acquired by the VM information collection unit 302 and the cause of abnormality such as I/F abnormality and IP address abnormality, etc., determined by the VM information collection unit 302. When the result corresponding to the instruction is not acquired (S50: NO), the VM state monitoring unit 204 determines whether a specified period of time has elapsed (S51).

When the specified period of time has not elapsed (S51: NO), the VM state monitoring unit 204 executes the process in S50. When the specified period of time has elapsed (S51: YES), the VM state monitoring unit 204 notifies the VM state management unit 203 that the VM 30 is in an abnormal halted state (S52). The VM state management unit 203 notified that the VM 30 is in an abnormal halted state notifies the terminal device 2 that the VM 30 is abnormally halted. When the result corresponding to the instruction is acquired (S50: YES), the VM state monitoring unit 204 notifies the VM state management unit 203 of the acquired result corresponding to the instruction (S53).

Next, the VM state monitoring unit 204 determines whether the packet monitoring is halted in response to an instruction from the VM state management unit 203 (S54). When the packet monitoring is not halted (S54: NO), the VM state monitoring unit 204 executes the process in S42. When the packet monitoring is halted (S54: YES), the VM state monitoring unit 204 instructs the packet monitoring unit 102 to stop the packet monitoring (S55), and finishes the procedure after stopping the packet monitoring performed by the VM state monitoring unit 204 itself.

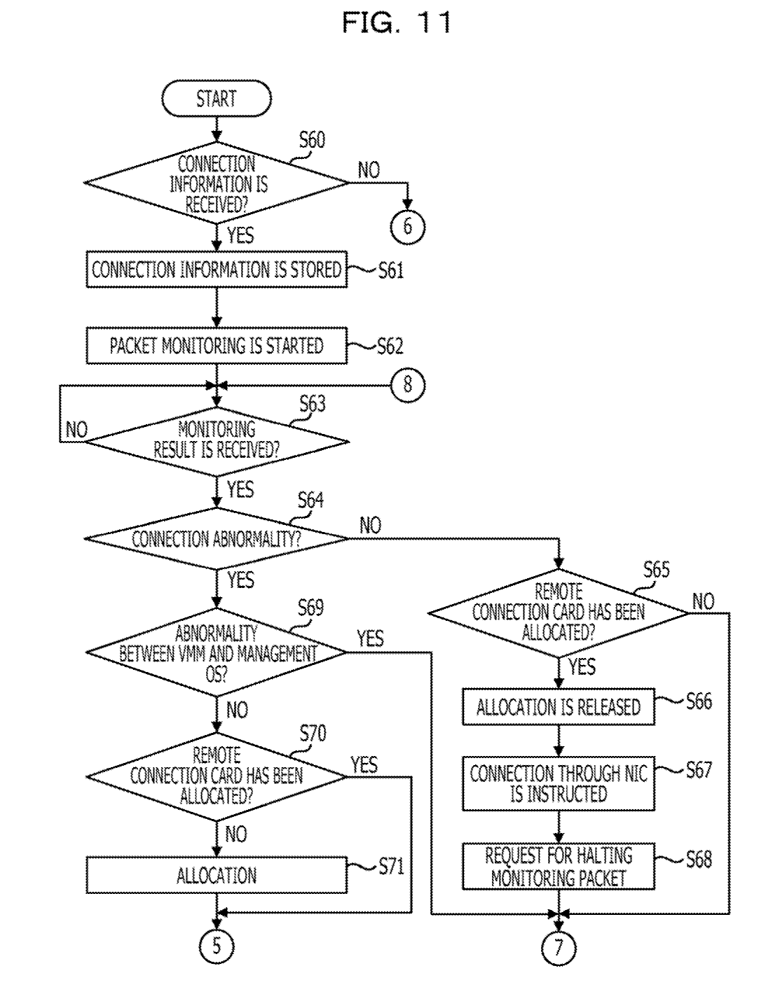

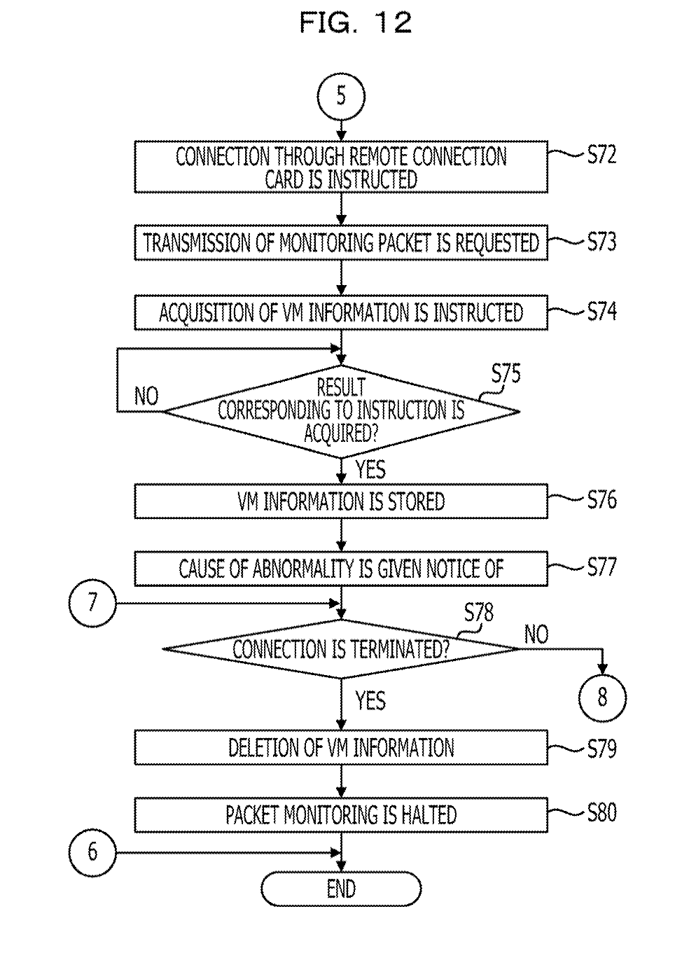

FIGS. 11 and 12 are flowcharts illustrating the procedure performed by the VM state management unit 203 in the management OS 20.

The VM state management unit 203 determines whether connection information is received from the network monitoring unit 301 in the VM 30 (S60). When a connection between the VM 30 and the terminal device 2 is established, the connection information is transmitted from the network monitoring unit 301. When the connection information is not received (S60: NO), the VM state management unit 203 terminates the procedure. When the connection information is received (S60: YES), the VM state management unit 203 stores the received connection information in the VM connection information storage unit 207 (S61).

The VM state management unit 203 starts packet monitoring (S62). When the packet monitoring is started, the VM state management unit 203 instructs the VM state monitoring unit 204 to start the packet monitoring. The VM state monitoring unit 204 instructed to start the packet monitoring further instructs the packet monitoring unit 102 in the VMM 10 to start the packet monitoring.

The VM state management unit 203 determines whether a result for the packet monitoring is received (S63). When the monitoring result is not received (S63: NO), the VM state management unit 203 waits until the monitoring result is received. When the monitoring result is received (S63: YES), the VM state management unit 203 determines whether the received monitoring result indicates connection abnormality (S64). The packet monitoring is performed in the VM state monitoring unit 204, the packet monitoring unit 102, and the network monitoring unit 301, and when it is determined, in these monitoring units, that connection abnormality does not occur, the VM state management unit 203 determines that the connection abnormality does not occur.

When the monitoring result does not indicate the connection abnormality (S64: NO), the VM state management unit 203 determines whether the remote connection card 1b has been allocated to the VM 30 (S65). When the remote connection card 1b has been allocated to the VM 30, the VM 30 is connected from the terminal device 2 via the remote connection card 1b. When the remote connection card 1b has been allocated to the VM 30 (S65: YES), it is determined that a connection between the VM 30 and the terminal device 2 is recovered from connection abnormality, and the VM state management unit 203 instructs the device allocation controller 202 to release the allocation of the remote connection card 1b (S66). By transmitting the IP address of the Virtual NIC 30a to the terminal device 2, the VM state management unit 203 instructs the terminal device 2 to connect to the VM 30 via the NIC is (S67). When the terminal device 2 connects to the VM 30 via the remote connection card 1b, a monitoring packet is transmitted from the terminal device 2, and hence the VM state management unit 203 requests the terminal device 2 to stop the transmission of the monitoring packet (S68). After that, the VM state management unit 203 executes a process in S78. In addition, when the remote connection card 1b is not allocated to the VM 30 (S65: NO), the VM state management unit 203 executes the process in S78.

When the monitoring result indicates the connection abnormality (S64: YES), the VM state management unit 203 determines whether the connection abnormality is an abnormality between the VMM 10 and the management OS 20 (S69). For example, when the VM state monitoring unit 204 determines the connection abnormality, the VM state management unit 203 determines the connection abnormality is a connection abnormality between the VMM 10 and the management OS 20. When it is determined that the connection abnormality is an abnormality between the VMM 10 and the management OS 20 (S69: YES), the VM state management unit 203 executes the process in S78. When it is determined that the connection abnormality is abnormality between the VMM 10 and the management OS 20, the connection abnormality is not solved even if a connection between the VM 30 and the terminal device 2 is established via the remote connection card 1b. Therefore, the VM state management unit 203 may notify the terminal device 2 of the cause of the abnormality.

When it is determined that the connection abnormality is not an abnormality between the VMM 10 and the management OS 20 (S69: NO), the VM state management unit 203 determines whether the remote connection card 1b has been allocated to the VM 30 (S70). When the remote connection card 1b has been allocated to the VM 30 (S70: YES), the VM state management unit 203 executes a process in S72. When the remote connection card 1b has not been allocated to the VM 30 (S70: NO), the VM state management unit 203 instructs the device allocation controller 202 to allocate the remote connection card 1b to the VM 30 (S71). Next, by transmitting the IP address of the allocated remote connection card 1b to the terminal device 2, the VM state management unit 203 instructs the terminal device 2 to connect to the VM 30 via the remote connection card 1b (S72). In addition, the VM state management unit 203 notifies the terminal device 2 of the IP address of the virtual NIC 30a, and requests the terminal device 2 to transmit a monitoring packet (S73).

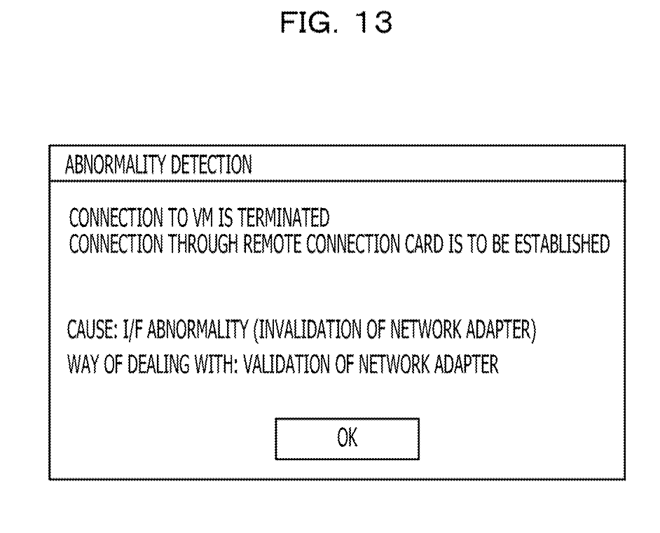

Next, the VM state management unit 203 instructs the VM state monitoring unit 204 to acquire the VM information (S74), and determines whether a result corresponding to the instruction is received (S75). As described above, the result corresponding to the instruction includes the VM information acquired by the VM information collection unit 302 and the causes of abnormality such as the I/F abnormality determined by the VM information collection unit 302, or the like. When the result corresponding to the instruction is not received (S75: NO), the VM state management unit 203 waits until the result corresponding to the instruction is received. When the result corresponding to the instruction is received (S75: YES), the VM state management unit 203 stores the received VM information in the VM management information storage unit 206 (S76), and notifies the terminal device 2 of the content of the abnormality (S77). In the terminal device 2 notified of the content of the abnormality, a warning screen used for informing a user is displayed. FIG. 13 is a schematic view illustrating an example of a screen for informing the user of abnormity, and is an example of a screen displayed when an I/F abnormality occurs. In this case, the invalidation of the network adapter (virtual NIC 30a) is displayed as the causes of the I/F abnormality. In addition, as a way of dealing with the I/F abnormality, the validation of the network adapter (virtual NIC 30a) is displayed.

When the VM state management unit 203 determines whether a connection between the VM 30 and the terminal device 2 is terminated (S78). When the connection between the VM 30 and the terminal device 2 is not terminated (S78: NO), the VM state management unit 203 executes the process in S63. When the connection between the VM 30 and the terminal device 2 is terminated (S78: YES), the VM state management unit 203 deletes the VM information stored in the VM management information storage unit 206 (S79), and stops the packet monitoring. At this time, the VM state management unit 203 instructs the VM state monitoring unit 204 to stop the packet monitoring (S80). Then, the VM state management unit 203 finishes the procedure.

When, owing to the erroneous establishment of the network configuration, it is unable to establish a connection between the VM 30 and the terminal device 2 via the NIC 1a, the VM 30 establishes a connection between the VM 30 and the terminal device 2 via the remote connection card 1b. Accordingly, the user of the terminal device 2 establishes the network configuration in the VM 30 again. As a result, since the user of the terminal device 2 removes the cause of the connection abnormality without requesting the administrator to remove the cause, an administrator's responsibility is reduced when the connection abnormality occurs, and the user saves an effort such as a request to the administrator.

In addition, while, in one embodiment, the icmp is used as a monitoring packet, a TCP/IP packet or a specific protocol may be used. When the TCP/IP packet is used, the terminal device 2 may be notified of a TCP port number used for a network connection, as a destination port number. Accordingly, it is not necessary to install a new module on the VM 30. For example, when an RDP connection is used in order to establish a connection between the VM 30 and the terminal device 2, a general default port number “3389” may be used as the destination TCP port number of the monitoring packet.

In addition, as an example of the packet monitoring, when the RDP connection is used for a network connection, the terminal device 2 transmits an SYN packet by specifying an IP address, allocated to the virtual NIC 30a in the VM 30, as a destination IP address and 3389/tcp as a destination port number. When receiving the SYN packet, the guest OS 40 running in the VM 30 sends, as a response packet, a [SYN, ACK] packet back to the terminal device 2 that is the transmission source of the SYN packet. Since the guest OS 40 sends back the response packet, the packet monitoring unit 102 or the like confirms whether a [SYN] packet is passing as a request packet. By confirming whether a [SYN, ACK] packet is passing as a response packet, the packet monitoring unit 102 or the like performs the packet monitoring.

### Another Embodiment

Hereinafter, another embodiment will be described. In the embodiment described above, the packet monitoring is always performed, while the connection is established between the VM 30 and the terminal device 2. On the other hand, in the present embodiment, the packet monitoring is performed when an abnormal connection occurs between the VM 30 and the terminal device 2. Hereinafter, how to start the packet monitoring when an abnormal connection occurs will be described.

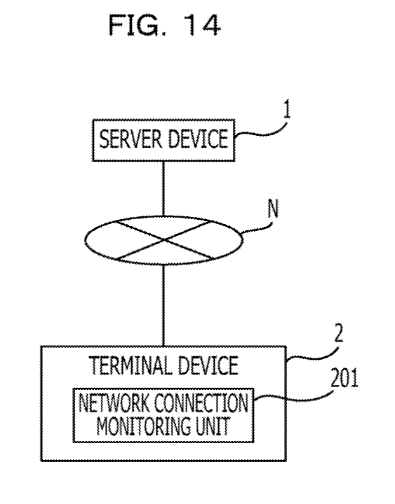

FIG. 14 is a block diagram schematically illustrating a function included in the terminal device 2. The terminal device 2 includes the function of a network connection monitoring unit 201. When detecting a request packet to be transmitted to the connected VM 30, the network connection monitoring unit 201 detects a response packet from the VM 30, which responds to the request packet. When the response packet has not been detected, the network connection monitoring unit 201 notifies the server device 1 of connection abnormality.

The server device 1 includes substantially the same function as that in the embodiment described above. When the network connection monitoring unit 201 in the terminal device 2 notifies the VM state management unit 203 according to the present embodiment of the connection abnormality, the VM state management unit 203 starts packet monitoring.

Hereinafter, procedures individually performed in the server device 1 and the terminal device 2 will be described.

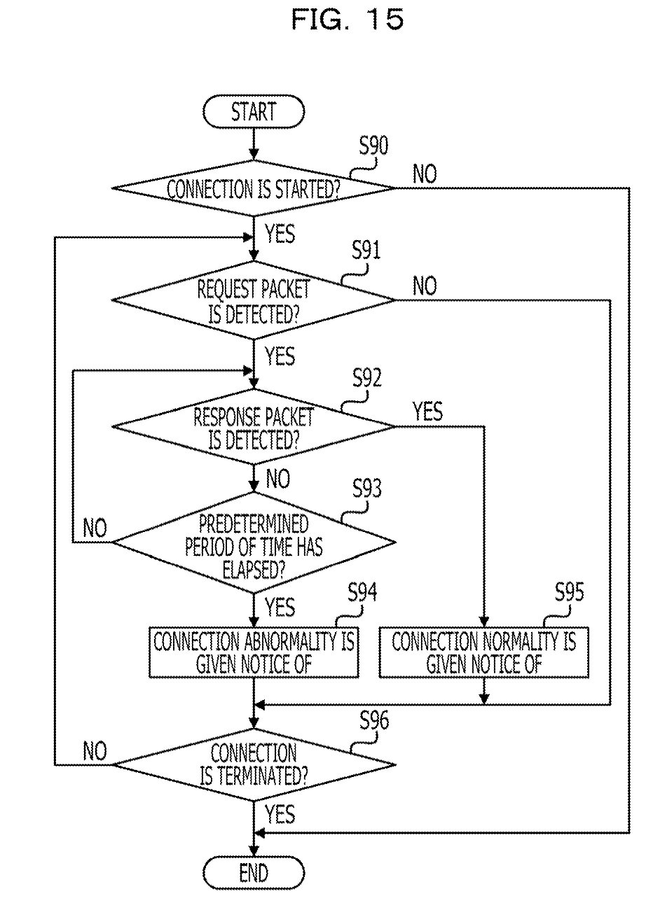

FIG. 15 is a flowchart illustrating the procedure performed by the network connection monitoring unit 201 in the terminal device 2.

The network connection monitoring unit 201 determines whether the terminal device 2 starts connecting to the VM 30 (S90). When the connection is not started (S90: NO), the network connection monitoring unit 201 terminates the procedure. When the connection is started (S90: YES), the network connection monitoring unit 201 starts the packet monitoring, and determines whether a request packet transmitted from the terminal device 2 to the VM 30 is detected (S91). When the request packet is not detected (S91: NO), the network connection monitoring unit 201 executes a process in S96.

When the request packet is detected (S91: YES), the network connection monitoring unit 201 determines whether a response packet from the VM 30, which responds to the request packet, is detected (S92). When the request packet is not detected (S92: NO), the network connection monitoring unit 201 determines whether a specified period of time has elapsed (S93). When the specified period of time has not elapsed (S93: NO), the network connection monitoring unit 201 executes a process in S92. When the specified period of time has elapsed (S93: YES), the network connection monitoring unit 201 determines that a connection abnormality between the terminal device 2 and the VM 30 occurs, and notifies the server device 1 of the connection abnormality (S94). When the response packet is detected (S92: YES), the network connection monitoring unit 201 determines that a connection between the terminal device 2 and the VM 30 is normal, and notifies the server device 1 of the connection normality (S95). In addition, when the connection between the terminal device 2 and the VM 30 is normal, the network connection monitoring unit 201 may not notify the server device 1 of the connection normality.

The network connection monitoring unit 201 determines whether the connection between the VM 30 and the terminal device 2 is terminated (S96). When the connection between the VM 30 and the terminal device 2 is not terminated (S96: NO), the network connection monitoring unit 201 executes the process in S91, and re-executes the packet monitoring. When the connection between the VM 30 and the terminal device 2 is terminated (S96: YES), the network connection monitoring unit 201 finishes the procedure.

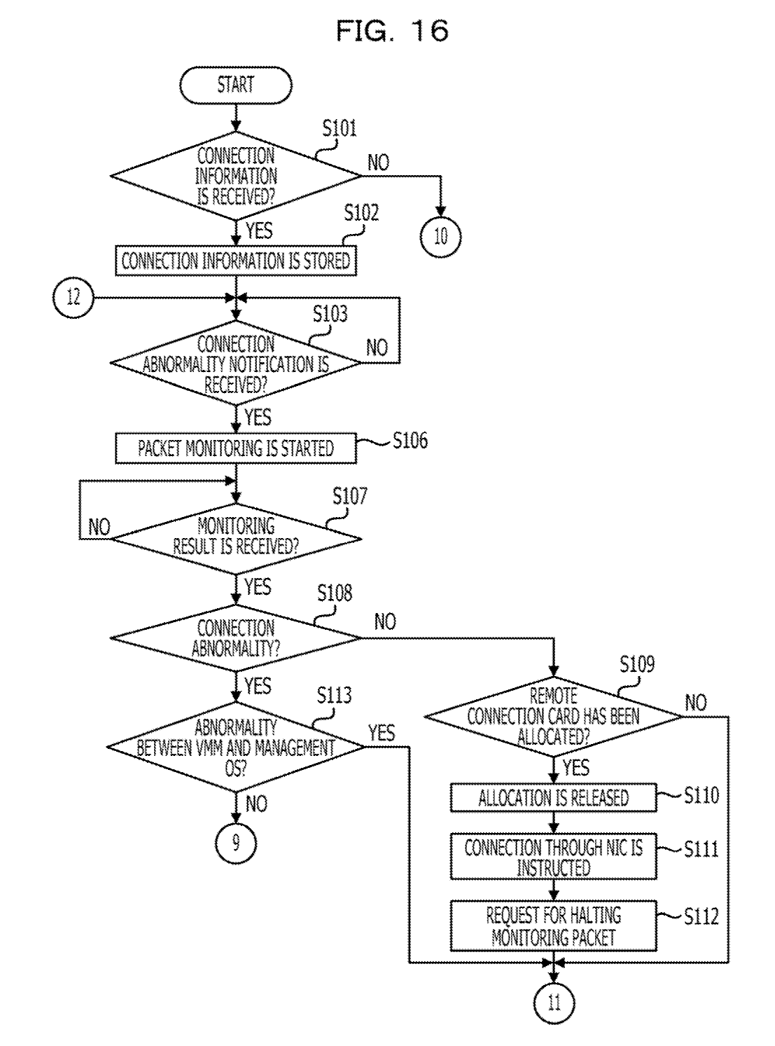

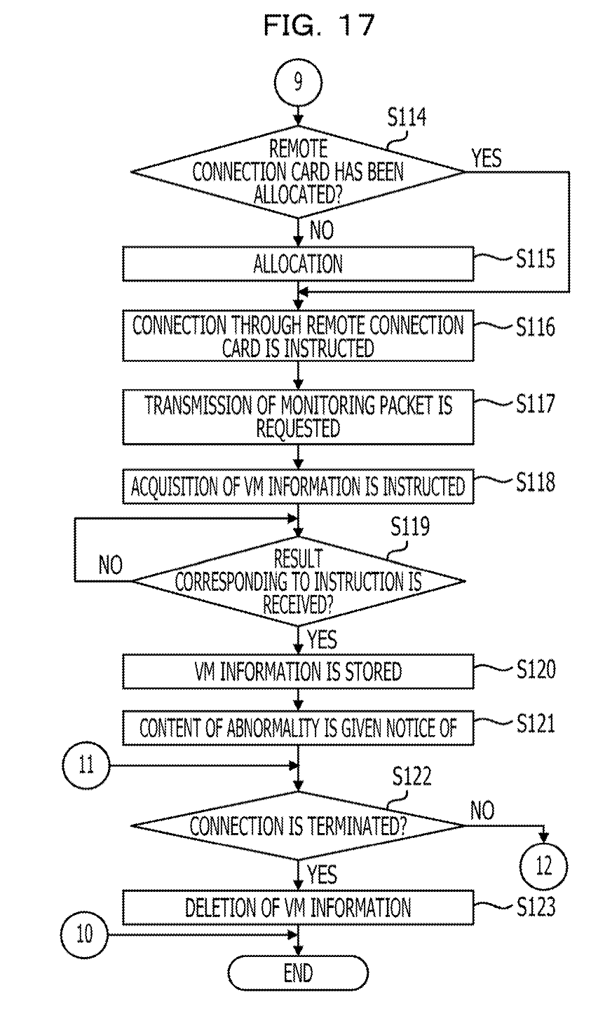

FIGS. 16 and 17 are flowcharts illustrating the procedure performed by the VM state management unit 203 in the management OS 20.

The VM state management unit 203 determines whether connection information is received from the network monitoring unit 301 in the VM 30 (S101). When the connection information is not received (S101: NO), the VM state management unit 203 terminates the procedure. When the connection information is received (S101: YES), the VM state management unit 203 stores the received connection information in the VM connection information storage unit 207 (S102).

The VM state management unit 203 determines whether a connection abnormality notification is received from the terminal device 2 (S103). When the connection abnormality notification is not received (S103: NO), namely, the connection between the VM 30 and the terminal device 2 is normal, the VM state management unit 203 waits until the connection abnormality notification is received.

When the connection abnormality notification is received (S103: YES), the VM state management unit 203 starts the packet monitoring (S106). When the packet monitoring is started, the VM state management unit 203 instructs the VM state monitoring unit 204 and the network monitoring unit 301 to start the packet monitoring. The VM state management unit 203 determines whether a result for the packet monitoring is received (S107). When the monitoring result is not received (S107: NO), the VM state management unit 203 waits until the monitoring result is received. When the monitoring result is received (S107: YES), the VM state management unit 203 determines whether the received monitoring result indicates connection abnormality (S108).

When the monitoring result does not indicate connection abnormality (S108: NO), the VM state management unit 203 determines whether the remote connection card 1b has been allocated to the VM 30 (S109). When the remote connection card 1b has been allocated to the VM 30 (S109: YES), the VM state management unit 203 instructs the device allocation controller 202 to release the allocation of the remote connection card 1b (S110). By transmitting the IP address of the virtual NIC 30a to the terminal device 2, the VM state management unit 203 instructs the terminal device 2 to connect to the VM 30 via the NIC is (S111), and instructs the terminal device 2 to stop the transmission of the monitoring packet (S112). After that, the VM state management unit 203 executes a process in S122. In addition, when the remote connection card 1b has not been allocated to the VM 30 (S109: NO), the VM state management unit 203 executes the process in S122.

When the monitoring result indicates the connection abnormality (S108: YES), the VM state management unit 203 determines whether the connection abnormality is abnormality between the VMM 10 and the management OS 20 (S113). When it is determined that the connection abnormality is abnormality between the VMM 10 and the management OS 20 (S113: YES), the VM state management unit 203 executes the process in S122. When it is determined that the connection abnormality is not abnormality between the VMM 10 and the management OS 20 (S113: NO), the VM state management unit 203 determines whether the remote connection card 1b has already been allocated to the VM 30 (S114).

When the remote connection card 1b has already been allocated to the VM 30 (S114: YES), the VM state management unit 203 executes a process in S116. When the remote connection card 1b has not been allocated to the VM 30 (S114: NO), the VM state management unit 203 instructs the device allocation controller 202 to allocate the remote connection card 1b to the VM 30 (S115). By transmitting the IP address of the remote connection card 1b to the terminal device 2, the VM state management unit 203 instructs the terminal device 2 to connect to the VM 30 via the remote connection card 1b (S116). In addition, the VM state management unit 203 notifies the terminal device 2 of the IP address of the virtual NIC 1a, and requests the terminal device 2 to transmit a monitoring packet (S117).

Next, the VM state management unit 203 instructs the VM state monitoring unit 204 to acquire the VM information (S118). The VM state management unit 203 determines whether a result corresponding to the instruction is received (S119). When the result corresponding to the instruction is not received (S119: NO), the VM state management unit 203 waits until the result corresponding to the instruction is received. When the result corresponding to the instruction is received (S119: YES), the VM state management unit 203 stores the received VM information in the VM management information storage unit 206 (S120), and notifies the terminal device 2 of the content of the abnormality (S121).

The VM state management unit 203 determines whether a connection between the VM 30 and the terminal device 2 is terminated (S122). When the connection between the VM 30 and the terminal device 2 is not terminated (S122: NO), the VM state management unit 203 executes the process in S103. When the connection between the VM 30 and the terminal device 2 is terminated (S122: YES), the VM state management unit 203 deletes the VM information stored in the VM management information storage unit 206 (S123), and finishes the procedure.

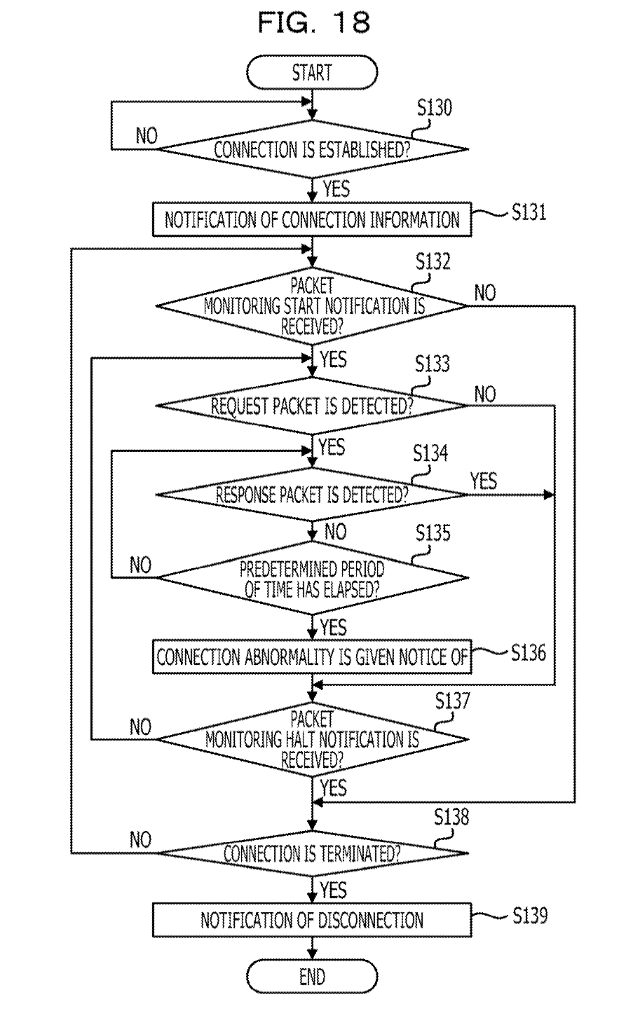

FIG. 18 is a flowchart illustrating the procedure performed by the network monitoring unit 301 in the VM 30.

The network monitoring unit 301 determines whether a connection between the VM 30 and the terminal device 2 is established (S130). When the connection between the VM 30 and the terminal device 2 is not established (S130: NO), the network monitoring unit 301 waits until the connection between the VM 30 and the terminal device 2 is established. When the connection between the VM 30 and the terminal device 2 is established (S130: YES), the network monitoring unit 301 gives notice of connection information such as the IP address of the terminal device 2 etc. (S131).

Next, the network monitoring unit 301 determines whether a packet monitoring start notification is received from the VM state management unit 203 (S132). When the packet monitoring start notification is not received (S132: NO), the network monitoring unit 301 executes a process in S138. When the packet monitoring start notification is received (S132: YES), the network monitoring unit 301 determines whether a request packet from the terminal device 2 is detected (S133). When the request packet is received (S133: YES), the network monitoring unit 301 determines whether a response packet from the guest OS 40, which responds to the request packet, is detected (S134).

When the response packet is not detected (S134: NO), the network monitoring unit 301 determines whether a specified period of time has elapsed (S135). When the specified period of time has not elapsed (S135: NO), the network monitoring unit 301 executes a process in S134. When the specified period of time has elapsed (S135: YES), the network monitoring unit 301 determines that connection abnormality occurs, and notifies the VM state management unit 203 in the management OS 20 of the connection abnormality (S136). In addition, when the request packet is not detected (S133: NO) or the response packet is detected (S134: YES), the network monitoring unit 301 executes a process in S137.

The network monitoring unit 301 determines whether a packet monitoring stop notification is received from the VM state management unit 203 (S137). When the packet monitoring stop notification is not received (S137: NO), the network monitoring unit 301 executes the process in S133. When the packet monitoring stop notification is received (S137: YES), the network monitoring unit 301 determines whether a connection between the VM 30 and the terminal device 2 is terminated (S138). When the connection between the VM 30 and the terminal device 2 is not terminated (S138: NO), the network monitoring unit 301 executes the processing operation in S132. When the connection between the VM 30 and the terminal device 2 is terminated (S138: YES), the network monitoring unit 301 notifies the management OS 20 of the disconnection (S139), and finishes the procedure.

When, owing to the erroneous establishment of the network configuration, it is unable to establish a connection between the VM 30 and the terminal device 2 via the NIC 1a, the VM 30 establish a connection between the VM 30 and the terminal device 2 via the remote connection card 1b. Accordingly, the user of the terminal device 2 establishes the network configuration in the VM 30 again. As a result, since the user of the terminal device 2 removes the cause of the connection abnormality without requesting the administrator to remove the cause, an administrator's responsibility is reduced, when connection abnormality occurs. Furthermore, the user can save an effort such as a request to the administrator, and a time period is reduced during which an operation is suspended owing to a waiting time taken for the administrator to identify the cause of the connection abnormality and restore the connection.

In addition, in the present embodiment, when the terminal device 2 gives notice of the connection abnormality, the server device 1 starts the packet monitoring, and hence a processing load on the server device 1 due to the packet monitoring is prevented from increasing. As a result, the possibility that the resource of the server device 1 is occupied by the process for the packet monitoring and hence another process performed in the server device 1 is influenced is prevented.

In addition, while, in the present embodiment, the network connection monitoring unit 201 detects network connection abnormality, thereby starting the packet monitoring, the user may be caused to select a notification when the server device 1 is notified of the connection abnormality.

### Another Embodiment

Hereinafter, another embodiment will be described. The server device 1 includes the plural remote connection cards 1b and the plural graphic cards 1c.

In addition to a case in which connection abnormality between the VM 30 and the terminal device 2 occurs, the server device 1 establishes a connection between the VM 30 and the terminal device 2 via the remote connection card 1b in response to a request from a user. In addition, in the present embodiment, when the connection abnormality between the VM 30 and the terminal device 2 occurs and there is no remote connection card 1b to be allocated to the VM 30, the allocation of the remote connection card 1b allocated to another VM 30 is released. In addition, the remote connection card 1b the allocation of which has been released is allocated to the corresponding VM 30. Hereinafter, the main operation of the present embodiment will be described.

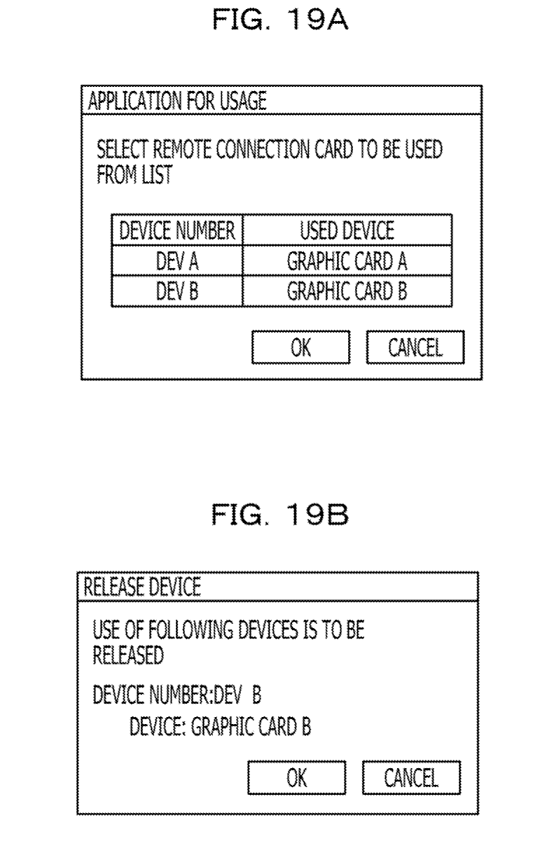

In the terminal device 2, by executing an application connected via the remote connection card 1b, a screen is displayed that is used for connecting the terminal device 2 to the VM 30 via the remote connection card 1b. FIG. 19A is a schematic view illustrating an example of a screen for allocating the remote connection card 1b, displayed on a monitor in the terminal device 2. In the screen illustrated in FIG. 19A, the list of available devices (the graphic cards is which is corresponding to the remote connection cards 1b) is displayed. The available devices are devices that have not been allocated to any one of the VMs 30 in the server device 1. When the user selects a device using the screen, the selected device (device number) is transmitted from the terminal device 2 to the server device 1. FIG. 19B is a schematic view illustrating an example of a screen for releasing the remote connection card 1b allocated to the VM 30, displayed on the monitor in the terminal device 2. In the screen illustrated in FIG. 19B, currently used devices (the graphic card is which is corresponding to the remote connection card 1b) are displayed, and a button is displayed that prompts the user to select whether the device is released. When the release is selected, the terminal device 2 notifies the server device 1 of the release of the device.

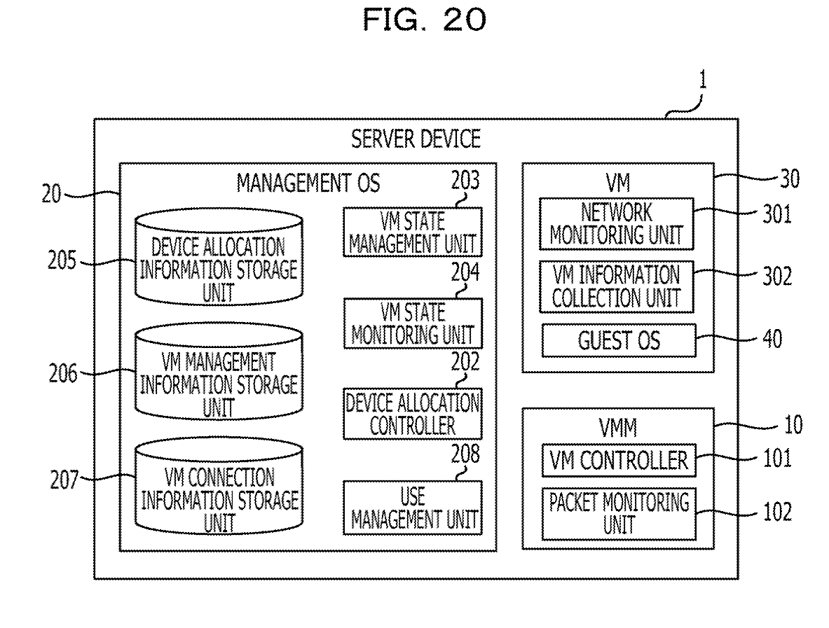

Hereinafter, a function realized in the server device 1 will be described. FIG. 20 is a block diagram illustrating the function included in the server device 1.

In addition to the function described in the first embodiment described above, the server device 1 further includes the function of a use management unit 208. The use management unit 208 runs on the management OS 20, and acquires the list of devices (the remote connection card 1b and the graphic card 1c) that have not been allocated to any one of the VMs 30. In addition, when accepting a use request for the remote connection card 1b from the terminal device 2, the use management unit 208 transmits the screen data illustrated in FIG. 19A to the terminal device 2. Furthermore, when receiving the device selected in the terminal device 2, the use management unit 208 instructs the VM state management unit 203 to allocate the selected device to the VM 30.

The VM state management unit 203 acquires the devices not allocated to any one of the VMs 30, on the basis of the device information stored in the device allocation information storage unit 205, and notifies the use management unit 208 of the devices. In addition, the VM state management unit 203 instructs the device allocation controller 202 to allocate the device such as the remote connection card 1b and the graphic card is which is corresponding to the remote connection card 1b, in response to an instruction from the use management unit 208. After the completion of the allocation, the VM state management unit 203 instructs, through the VM state monitoring unit 204, the VM information collection unit 302 to acquire the usage rate (operation rate) of a resource (for example, a graphics processing unit: GPU) in the VM 30 to which the device is allocated. For example, the usage rate of the resource is an average value during a specified period of time.

In a case in which there is no unallocated remote connection card 1b when a connection between the VM 30 and the terminal device 2 is to be established via the remote connection card 1b, the VM state management unit 203 specifies a remote connection card 1b the allocation of which is to be temporarily released, on the basis of the usage rate of the resource. For example, it is determined that a remote connection card 1b, allocated to the VM 30 the usage rate of the resource of which is lowest, is to be released. Alternatively, it is determined that a remote connection card 1b is to be released from the VM 30 the user of which has occupied the remote connection card 1b for a long time. Then, the VM state management unit 203 instructs the device allocation controller 202 to release the allocation of the selected remote connection card 1b.

Hereinafter, a procedure performed in the server device 1 will be described. In addition, substantially the same procedure as that in the first embodiment described above may be used as a procedure performed when a connection between the VM 30 and the terminal device 2 is abnormal and a connection between the VM 30 and the terminal device 2 is established via the remote connection card 1b.

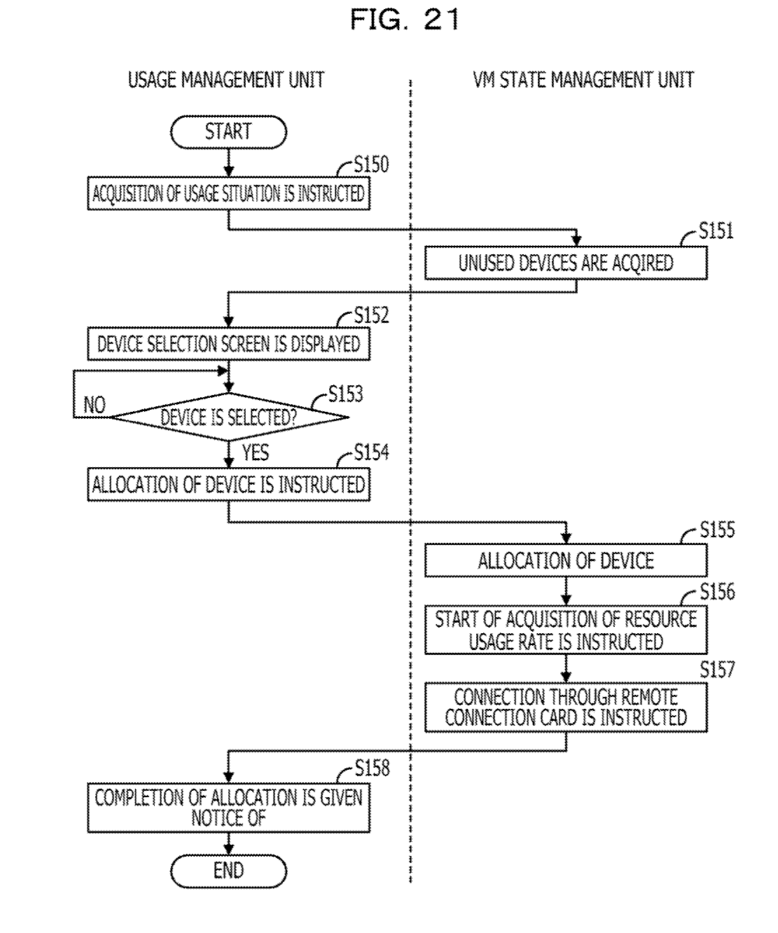

FIG. 21 is a flowchart illustrating the procedure performed by the server device 1 when it is started to use the remote connection card 1b. In FIG. 21, the procedures performed in the use management unit 208 and the VM state management unit 203 are illustrated.

When a user executes on the terminal device 2 an application used for applying for the use of devices (the remote connection card 1b and the graphic card 1c), the use management unit 208 instructs the VM state management unit 203 to acquire the use state of the device (S150). The instructed VM state management unit 203 acquires from the device allocation information storage unit 205 a device that is not allocated to the VM 30, and notifies the use management unit 208 of the devices (S151).

The use management unit 208 makes a device selection screen (refer to FIG. 19A) to be displayed on the monitor in the terminal device 2 (S152). The list of the devices acquired in S151 is displayed on the device selection screen. The use management unit 208 determines whether a device is selected on the device selection screen (S153). When the device is not selected (S153: NO), the use management unit 208 waits until the device is selected. When the device is selected (S153: YES), the use management unit 208 instructs the VM state management unit 203 to allocate the selected device (S154).

The VM state management unit 203 instructs the device allocation controller 202 to allocate the specified device (S155), and instructs the VM information collection unit 302 in the VM 30 to which the device is allocated to acquire the resource usage rate (S156). The instructed VM information collection unit 302 periodically acquires the usage rate of a resource. By transmitting the IP address of the allocated remote connection card 1b to the terminal device 2, the VM state management unit 203 instructs the terminal device 2 to connect to the VM 30 via the remote connection card 1b (S157). After that, the use management unit 208 notifies the terminal device 2 of the completion of the device allocation (S158), and the procedure is finished.

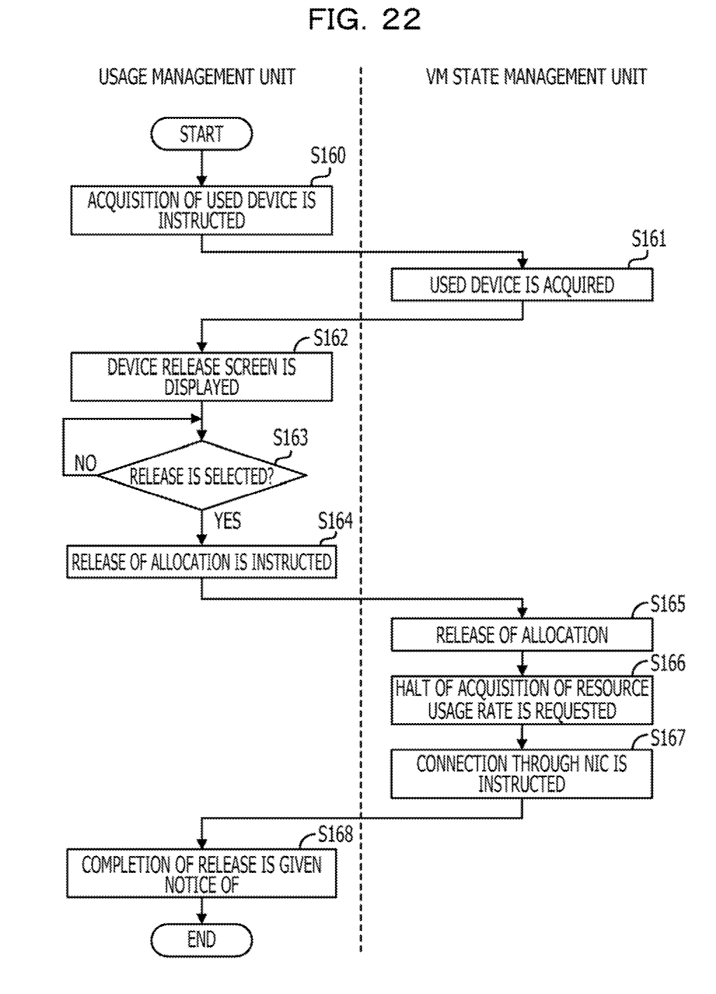

FIG. 22 is a flowchart illustrating the procedure performed by the server device 1 when it is ended to use the remote connection card 1b. In FIG. 22, the procedures performed in the use management unit 208 and the VM state management unit 203 are illustrated.

When a user executes on the terminal device 2 an application used for applying for the use termination of devices (the remote connection card 1b and the graphic card 1c), the use management unit 208 instructs the VM state management unit 203 to acquire a device allocated to the VM 30 used by the terminal device 2 (S160). The instructed VM state management unit 203 acquires from the device allocation information storage unit 205 a device currently allocated to the VM 30 used by the terminal device 2, and notifies the use management unit 208 of the devices (S161).

The use management unit 208 makes the device release screen (refer to FIG. 19B) to be displayed on the monitor in the terminal device 2 (S162). The device currently allocated to the VM 30 used by the terminal device 2 is displayed on the device release screen. The use management unit 208 determines whether device release is selected on the device release screen (S163). When the device release is not selected (S163: NO), the use management unit 208 waits until the device release is selected. When the device release is selected (S163: YES), the use management unit 208 instructs the VM state management unit 203 to release the allocation of the devices (S164).

The VM state management unit 203 instructs the device allocation controller 202 to release the allocation of the device (S165), and instructs the VM information collection unit 302 in the VM 30 to which the device has been allocated to stop the acquisition of the resource usage rate (S166). By transmitting the IP address of the virtual NIC 30a to the terminal device 2, the VM state management unit 203 instructs the terminal device 2 to connect to the VM 30 via the NIC is (S167). After that, the use management unit 208 notifies the terminal device 2 of the completion of the release of the device allocation (S168), and the procedure is finished.

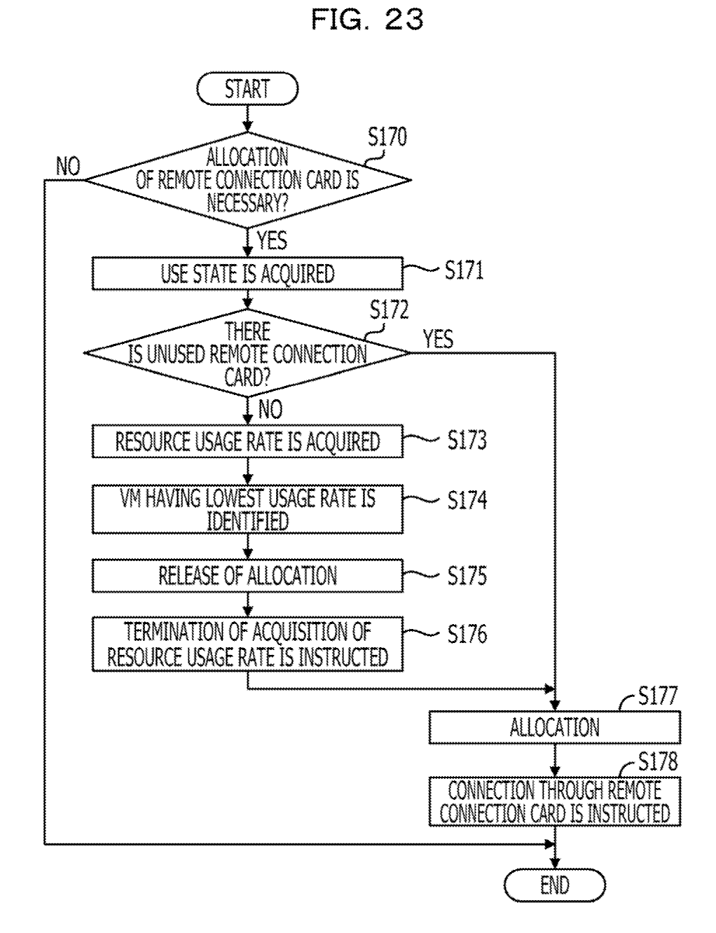

FIG. 23 is a flowchart illustrating the procedure performed by the server device 1 when it temporarily releases the allocated devices. The procedure illustrated in FIG. 23 is executed by the VM state management unit 203.

Owing to the occurrence of connection abnormality between the VM 30 and the terminal device 2, the VM state management unit 203 determines whether the remote connection card 1b is to be allocated to the VM 30 (S170). When the remote connection card 1b is not to be allocated to the VM 30 (S170: NO), the VM state management unit 203 terminates the procedure. When the remote connection card 1b is to be allocated to the VM 30 (S170: YES), the VM state management unit 203 acquires the use state of the devices from device information stored in the device allocation information storage unit 205 (S171).

Next, on the basis of the acquired use state, the VM state management unit 203 determines whether there is an unused remote connection card 1b, namely, a remote connection card 1b that has not been allocated to any one of the VMs 30 (S172). When there is an unused remote connection card 1b (S172: YES), the VM state management unit 203 allocates the unused remote connection card 1b to the corresponding VM 30 (S177). For example, the VM state management unit 203 instructs the device allocation controller 202 to perform the allocation. In addition, by transmitting the IP address of the allocated remote connection card 1b to the terminal device 2, the VM state management unit 203 instructs the terminal device 2 to connect to the VM 30 via the remote connection card 1b (S178). After that, the VM state management unit 203 finishes the procedure.

When there is no unused remote connection card 1b (S172: NO), the VM state management unit 203 acquires the usage rate of a resource from the VM 30 to which the remote connection card 1b is allocated (S173). The VM 30 to which the remote connection card 1b is allocated periodically performs the acquisition of the usage rate of a resource. The VM state management unit 203 identifies the VM 30 from which a usage rate of a resource is acquired, the usage rate being lowest usage rate among the acquired usage rates of resources (S174).

The VM state management unit 203 instructs the device allocation controller 202 to release the remote connection card 1b allocated to the selected VM 30 (S175). At this time, the VM state management unit 203 notifies the terminal device 2, which has used the remote connection card 1b to be released, of the temporal release of the allocated remote connection card 1b. Next, the VM state management unit 203 instructs the selected VM 30 to terminate the acquisition of the usage rate of a resource (S176). In addition, the VM state management unit 203 allocates the released remote connection card 1b to VM 30 to which the remote connection card 1b is to be allocated (S177). Next, by transmitting the IP address of the allocated remote connection card 1b to the terminal device 2, the VM state management unit 203 instructs the terminal device 2 to connect to the VM 30 via the remote connection card 1b (S178). After that, the VM state management unit 203 finishes the procedure.

As described above, in the present embodiment, the remote connection card 1b may be used in cases including a case in which connection abnormality occurs. In a case in which a connection between the VM 30 and the terminal device 2 is established via the NIC 1a, when the usage rate of a resource in the server device 1 increases, a transmission rate between the VM 30 and the terminal device 2 may decrease. At this case, by directly establishing a connection between the VM 30 and the terminal device 2 via the remote connection card 1b, the influence due to the increased usage rate of a resource is avoided.

In addition, when there is no unused remote connection card 1b, the allocation of the remote connection card 1b allocated to the VM 30 having the lowest usage rate of a resource is released. By releasing the allocated remote connection card 1b from the VM 30 having a lower usage rate of a resource, namely a lower operation rate of a resource, an influence due to the forced release of the allocated remote connection card 1b is reduced to a minimum.

In addition, while, in the present embodiment, the allocated remote connection card 1b to the VM 30 having the lowest usage rate of a resource is released, the allocated remote connection card 1b is not limited to the example. For example, as described above, the VM 30 the user of which has occupied a remote connection card for a long time is identified, and the allocated remote connection card 1b may be released, thereby allocating the remote connection card 1b to another VM 30.

### Another Embodiment

Hereinafter, another embodiment will be described. In the present embodiment, when a computer virus is detected in the guest OS 40 in the VM 30, a connection between the VM 30 and the terminal device 2 is established via the remote connection card 1b. In addition, substantially the same procedure as that in the first embodiment described above may be used as a procedure performed when a connection between the VM 30 and the terminal device 2 is abnormal and a connection between the VM 30 and the terminal device 2 is established via the remote connection card 1b.

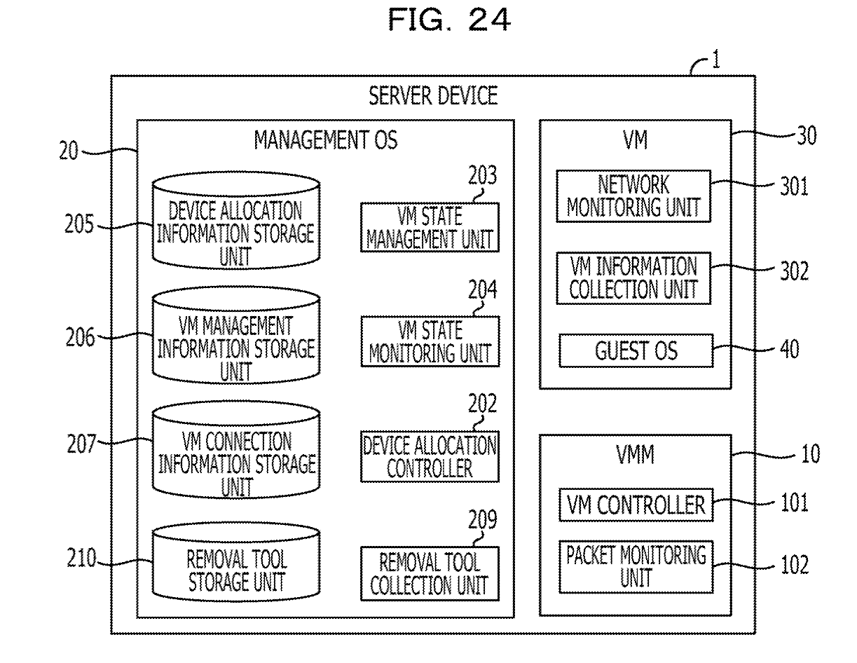

FIG. 24 is a block diagram illustrating a function included in the server device 1.

In addition to the function described in the first embodiment described above, the server device 1 further includes the functions of a removal tool collection unit 209 and a removal tool storage unit 210. The removal tool collection unit 209 runs on the management OS 20, and periodically acquires and stores a removal tool used for removing the computer virus or a virus definition file from the outside and in the removal tool storage unit 210. Information stored in the removal tool storage unit 210 includes identification information used for identifying the removal tool and the virus definition file, a date and time when the removal tool and the virus definition file were updated, a file path in which the removal tool and the virus definition file are stored, and the like.

When the VM state monitoring unit 204 notifies the VM state management unit 203 of virus detection, the VM state management unit 203 notifies the terminal device 2 of the virus detection, and notifies the terminal device 2 of the procedure get rid of viruses. After the notification, the VM state management unit 203 allocates the remote connection card 1b to the VM 30 in which the virus has been detected, acquires the removal tool and the like from the removal tool storage unit 210, and transfers the removal tool and the like to the VM 30 through the VM state monitoring unit 204. When the VM state monitoring unit 204 notifies the VM state management unit 203 of the completion gets rid of viruses, the VM state management unit 203 releases the remote connection card 1b allocated to the VM 30, and instructs the terminal device 2 to connect via NIC 1a.

When the VM information collection unit 302 notifies the VM state monitoring unit 204 of virus detection, the VM state monitoring unit 204 notifies the VM state management unit 203 of the virus detection. In addition, when the VM information collection unit 302 notifies the VM state monitoring unit 204 of the completion gets rid of viruses, the VM state monitoring unit 204 notifies the VM state management unit 203 of the completion gets rid of viruses. The VM state monitoring unit 204 receives the removal tool and the like from the VM state management unit 203 and transfers the received removal tool to the VM 30.

When a virus is detected by an application executed in the guest OS 40, the VM information collection unit 302 invalidates a network adapter (virtual NIC 30a), and notifies the VM state monitoring unit 204 of the virus detection. In addition, when a virus has not been detected, the VM information collection unit 302 validates the network adapter that has been invalidated, and notifies the VM state monitoring unit 204 of the completion of a virus removal.

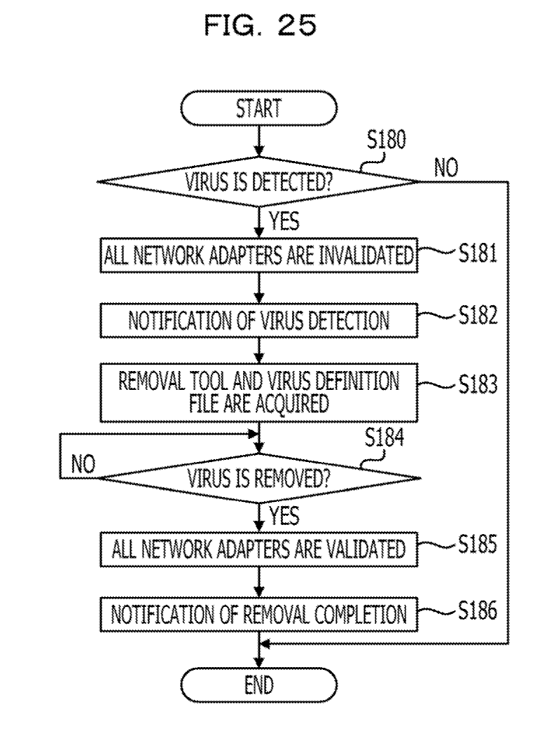

FIG. 25 is a flowchart illustrating the procedure performed by the VM information collection unit 302 in the VM 30.

The VM information collection unit 302 determines whether a virus is detected in the guest OS 40 (S180). For example, the virus detection is performed by a malware detection application executed in the guest OS 40. When no virus is detected (S180: NO), the VM information collection unit 302 terminates the procedure. When the virus is detected (S180: YES), the VM information collection unit 302 invalidates all network adapters used by the VM 30, for example, the virtual NIC 30a (S181).

Next, the VM information collection unit 302 notifies the VM state management unit 203 of the virus detection through the VM state monitoring unit 204 (S182), and as a result, the VM information collection unit 302 acquires a removal tool and a virus definition file, transmitted from the VM state management unit 203 (S183).

The VM information collection unit 302 determines whether virus removal is completed using the acquired removal tool and the like (S184). The virus removal may be performed by the user of the terminal device 2 or automatically performed. When the virus removal is not completed (S184: NO), the VM information collection unit 302 waits until the virus removal is completed. When the virus removal is completed (S184: YES), the VM information collection unit 302 validates all invalidated network adapters, for example the virtual NIC 30a (S185). In addition, the VM information collection unit 302 notifies the VM state management unit 203 of the completion of the virus removal through the VM state monitoring unit 204 (S186). After that, the VM information collection unit 302 finishes the procedure.

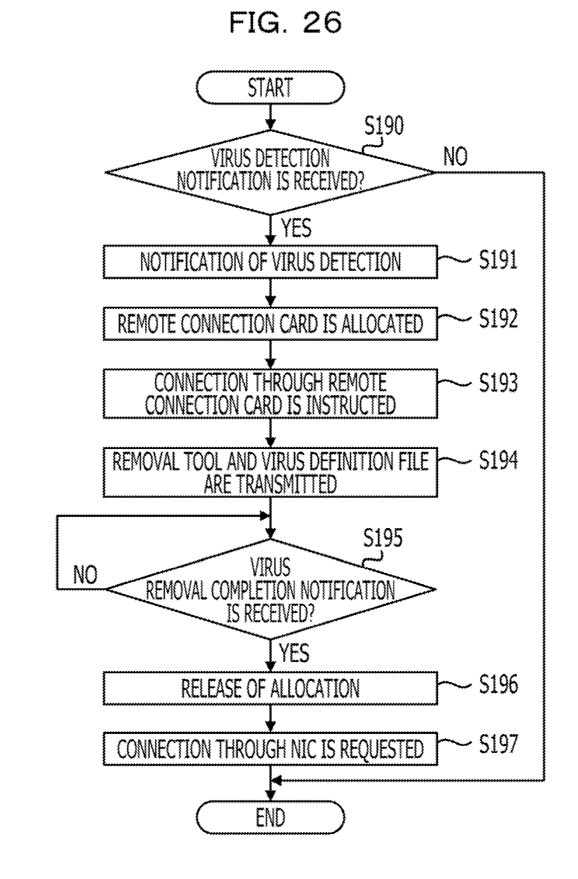

FIG. 26 is a flowchart illustrating the procedure performed by the VM state management unit 203 in the management OS 20.

The VM state management unit 203 determines whether a virus detection notification is received from the VM information collection unit 302 (S190). When the virus detection notification is not received (S190: NO), the VM state management unit 203 terminates the procedure. When the virus detection notification is received (S190: YES), the VM state management unit 203 notifies the terminal device 2 corresponding to the VM 30 in which the virus has been detected of the virus detection (S191).

The VM state management unit 203 instructs the device allocation controller 202 to allocate the remote connection card 1b to the VM 30 in which the virus has been detected (S192). By transmitting the IP address of the allocated remote connection card 1b to the terminal device 2, the VM state management unit 203 instructs the terminal device 2 to connect to the VM 30 via the remote connection card 1b (S193).

The VM state management unit 203 acquires the removal tool and the virus definition file from the removal tool storage unit 210, and transmits the removal tool and the virus definition file to the VM 30 through the VM state monitoring unit 204 (S194). The VM state management unit 203 determines whether a virus removal completion notification is received from the VM information collection unit 302 (S195). When the virus removal completion notification is not received (S195: NO), the VM state management unit 203 waits until the virus removal completion notification is received. When the virus removal completion notification is received (S195: YES), the VM state management unit 203 instructs the device allocation controller 202 to release the allocated remote connection card 1b (S196). By transmitting the IP address of the virtual NIC 30a to the terminal device 2, the VM state management unit 203 instructs the terminal device 2 to connect to the VM 30 via the NIC is (S197). In addition, the VM state management unit 203 finishes the procedure.

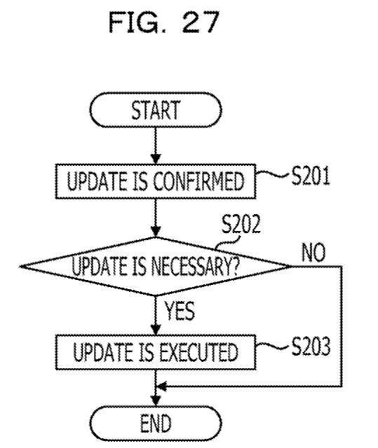

FIG. 27 is a flowchart illustrating the procedure performed by the removal tool collection unit 209 in the management OS 20.

The removal tool collection unit 209 confirms the date of the update of the removal tool and the virus definition file stored in the removal tool storage unit 210 (S201), and determines whether the removal tool and the virus definition file are to be updated (S202). For example, when the removal tool collection unit 209 accesses an external server device etc., and there is new data after the acquired date of the update, the removal tool collection unit 209 determines that the removal tool and the virus definition file are to be updated. When the removal tool and the virus definition file are not to be updated (S202: NO), the removal tool collection unit 209 terminates the procedure. When it is determined that the removal tool and the virus definition file are to be updated (S202: YES), the removal tool collection unit 209 updates the removal tool and the virus definition file stored in the removal tool storage unit 210, using download etc. (S203), and finishes the procedure.

As described above, in the present embodiment, when a virus is detected, a connection between the VM 30 and the terminal device 2 is directly established via the remote connection card 1b. Accordingly, the influence of the virus to the VMM 10 or the management OS 20 in the server device 1 is avoided. In addition, when a virus is detected, the connection between the VM 30 and the terminal device 2 is not completely disconnected but the connection between the VM 30 and the terminal device 2 is established via the remote connection card 1b, thereby performing the removal of the virus or the measure for the virus.

While the embodiments have been specifically described as above, the individual configurations and the individual operations may be arbitrarily changed and are not limited to the above-mentioned embodiments.

The programs according to the embodiments are recorded on a computer-readable storage medium and distributed. The computer-readable storage medium is, for example, a non-volatile storage medium, such as a flexible disc, a hard disc, a compact disc read only memory (CD-ROM), a magneto-optical disc (MO), a DVD, a DVD-ROM, a DVD random access memory (DVD-RAM), a Blu-ray disc (BD), a USB memory, or a semiconductor memory. The computer programs may be transmitted via an electric communication line, a wireless or wire communication line, or a network, such as the Internet. The computer-readable storage medium does not include carrier waves containing a computer program. For a computer program embedded in carrier waves, a readable storage medium containing the program is provided to the computer that originally transmitted the carrier wave. Therefore, a computer-readable storage medium is a physically tangible storage medium.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. An information processing device comprising:
first and second communication units to which an external device is connected through a network;
a processing unit that executes a processing operation; and
a memory unit that stores the processing operation and information used in the processing operation,
wherein the processing operation executed by the processing unit includes
a virtual machine processing operation for causing a virtual machine used by the external device to operate,
a first connection processing operation for logically connecting the first communication unit and the virtual machine to each other,
an address notification processing operation for giving notice of first address information indicating a transmission destination of data to be transmitted by the external device and causing the external device to set the first address information, when a connection is established on the basis of the first connection processing operation,
a first determination processing operation for determining whether there is an abnormal connection between the first communication unit and the virtual machine,
a second connection processing operation for logically connecting the second communication unit and the virtual machine to each other when the first determination processing operation determines that there is an abnormal connection, and
a switching processing operation for giving notice of second address information indicating a transmission destination of data to be transmitted by the external device and causing the external device to switch to the second address information, when a connection is established on the basis of the second connection processing operation.

2. The information processing device according to claim 1, further comprising:
a second determination processing operation for determining whether an abnormal connection between the first communication unit and the virtual machine is solved, when the transmission destination of data to be transmitted by the external device is switched to the second communication unit on the basis of the switching processing operation,
wherein when it is determined on the basis of the second determination processing operation that the abnormal connection is solved, the switching processing operation gives notice of the first address information indicating the transmission destination of data to be transmitted by the external device, and causes the external device to switch to the first address information.

3. The information processing device according to claim 2, wherein
the second determination processing operation includes an instruction processing operation for instructing the external device to transmit a first signal to the first communication unit, wherein
when a second signal responding to the first signal is output from the virtual machine, it is determined that the abnormal connection between the first communication unit and the virtual machine is solved.

4. The information processing device according to claim 3, wherein
the instruction processing operation instructs the external device to transmit ICMP packet data.

5. The information processing device according to claim 3, wherein
the instruction processing operation instructs the external device to transmit TCP packet data.

6. The information processing device according to claim 1, wherein
when the first determination processing operation receives a third signal from the external device, the first determination processing operation performs determination.

7. The information processing device according to claim 1, further comprising:
a reception processing operation for displaying a list of the available second communication units, and accepting a usage request for the second communication unit selected from among the displayed list; and
a second connection processing operation for logically connecting the second communication unit and the virtual machine to each other, when the usage request is accepted.

8. The information processing device according to claim 1, wherein the virtual machine processing operation causes another virtual machine other than the virtual machine to operate, the information processing device further comprising:
a third determination processing operation for determining whether the second communication unit is logically connected to the other virtual machine, when the first determination processing operation determines that there is abnormality in the connection of the virtual machine;
an operation-rate acquisition processing operation for acquiring an operation rate of the other virtual machine, when it is determined that the second communication unit is logically connected to the other virtual machine; and
a disconnection determination processing operation for determining on the basis of the acquired operation rate whether a connection between the second communication unit and the other virtual machine is to be terminated, wherein
when it is determined that the connection between the second communication unit and the other virtual machine is to be terminated, the second connection processing operation logically connects the second communication unit and the virtual machine to each other.

9. The information processing device according to claim 8, wherein
a plurality of the other virtual machines operate and include a plurality of the second communication units,
the third determination processing operation determines whether all of the second communication units are logically connected to the other virtual machines,
the operation-rate acquisition processing operation acquires individual operation rates of the other virtual machines to which the second communication units are connected, and
the disconnection determination processing operation determines that a connection between the other virtual machine and the second communication unit, which correspond to a lowest operation rate acquired by the operation-rate acquisition processing operation, is to be terminated.

10. The information processing device according to claim 1, further comprising:
a virus determination processing operation for determining whether a virus is detected in the virtual machine; and
a disconnection processing operation for terminating the connection between the first communication unit and the virtual machine when the virus is detected, wherein
the second connection processing operation logically connects the second communication unit and the virtual machine to each other when the connection is terminated.

11. The information processing device according to claim 10, further comprising:
a virus determination processing operation for determining whether a virus in the virtual machine is removed, when the second connection processing operation connects the second communication unit and the virtual machine to each other, wherein
when the virus is removed, the first connection processing operation connects the first communication unit and the virtual machine to each other, and
when a connection is established on the basis of the first connection processing operation, the switching processing operation gives notice of the first address information indicating the transmission destination of data to be transmitted by the external device, and causes the external device to switch to the first address information.

12. A virtual machine connection method executed in a computer that includes first and second communication units to which an external device is connected through a network, a processing unit that executes a processing operation, and a memory unit that stores the processing operation and information used in the processing operation, the virtual machine connection method comprising;
a virtual machine processing operation for causing a virtual machine used by the external device to operate,
a first connection processing operation for logically connecting the first communication unit and the virtual machine to each other,
an address notification processing operation for giving notice of first address information indicating a transmission destination of data to be transmitted by the external device and causing the external device to set the first address information, when a connection is established on the basis of the first connection processing operation,
a first determination processing operation for determining whether there is an abnormal connection between the first communication unit and the virtual machine,
a second connection processing operation for logically connecting the second communication unit and the virtual machine to each other when the first determination processing operation determines that there is an abnormal connection, and
a switching processing operation for giving notice of second address information indicating a transmission destination of data to be transmitted by the external device and causing the external device to switch to the second address information, when a connection is established on the basis of the second connection processing operation.

13. A program that is stored in a computer-readable recording medium and executed in a computer including first and second communication units, the program comprising:
a virtual machine processing operation for causing a virtual machine used by the external device to operate,
a first connection processing operation for logically connecting the first communication unit and the virtual machine to each other,
an address notification processing operation for giving notice of first address information indicating a transmission destination of data to be transmitted by the external device and causing the external device to set the first address information, when a connection is established on the basis of the first connection processing operation,
a first determination processing operation for determining whether there is an abnormal connection between the first communication unit and the virtual machine,
a second connection processing operation for logically connecting the second communication unit and the virtual machine to each other when the first determination processing operation determines that there is an abnormal connection, and
a switching processing operation for giving notice of second address information indicating a transmission destination of data to be transmitted by the external device and causing the external device to switch to the second address information, when a connection is established on the basis of the second connection processing operation.
